(19) United States
(12) Patent Application Publication
(10) Pub. No.: US 2014/0337223 A1
(43) Pub. Date: Nov. 13, 2014

(54) MODULARITY IN A LEARNING SYSTEM

(71) Applicant: Samridh Kapoor, Ashfield (IN)

(72) Inventor: Samridh Kapoor, Ashfield (IN)

(73) Assignee: MONK AKARSHALA DESIGN PVT LTD, Mumbai, Maharashtra (IN)

(21) Appl. No.: 14/237,561

(22) PCT Filed: Aug. 8, 2012
(86) PCT No.: PCT/IB2012/002108

§ 371 Date: Jul. 25, 2014

(30) Foreign Application Priority Data
Aug. 10, 2011 (IN) 2249/MUM/2011

(51) Int. Cl. G06Q 20/12; G06Q 50/20

(52) U.S. Cl. CPC G06Q 20/12; G06Q 50/20
USPC 705/44

(57) ABSTRACT

A system and a method are disclosed for managing the purchase and performance of a microlearning stack comprising a learning application and associated application services in a modular learning system by a learning user. Application services include access to tutoring services, learning facilities, learning tools, and other services associated with each learning application. Learning applications are stored in a modular learning system and include a variety of metadata used to determine compatibility to learning users and application services before purchase or performance of a microlearning stack. The modular learning system determines the purchase compatibility, performance compatibility and service availability of micro learning stacks before granting or denying purchase or performance of the learning application and associated application services in the requested stack.

### CROSS REFERENCE TO RELATED APPLICATIONS

This application claims the benefit of Indian Provisional Specification No. 2249/MUM/2011, titled “Modularity in a Learning System” filed on 10 Aug. 2011, which is incorporated by reference in its entirety.

### FIELD OF THE ART

The present disclosure relates generally to learning management systems, and more particularly to systems and methods of managing the purchase and performance of microlearning services comprising learning applications and associated application service stacks, in a modular learning system environment.

### DESCRIPTION OF THE RELATED ART

Educational environments include participation of a variety of entities such as students or learners, teachers, tutors, coaches, guides, professors or lecturers, content authors, and organizational members like preschools, schools, colleges, universities, educational boards and professional standards authorities, admission testing authorities, placement organizations, recruiters, HR departments of organizations, educational content and media publishers and local, regional, and national governments. These members maintain transactional and functional relationships with each other.

Conventionally, schools, colleges and universities provide services in an integrated and macro manner in which tutoring services, physical learning facilities, learning tools, aids or materials, are purchased, managed and delivered in large chunks of time and money like years and yearly admission fees.

Typical learning management systems organize macro learning services within an individual institutional environment. As a result, every school, college or university operates the learning management system with no interoperability between them. A learner wishing to learn a standard level 8 biology course from a tutor in his school and a standard level 10 mathematics course from a tutor in another school is restricted in the present educational system as there are no means available by which he can manage both courses at the same time.

Some computer-based learning systems provide access to learning services remotely to users through a computer based interface. However, such systems fail to manage the learner's learning performances in learning tasks relating to doing (praxis) and making (poeisis). These systems typically designate a specific curriculum for online performance. For example, performances which require a physical or non-computer based interface, like learning swimming or sculpting, or theatre, are not managed by these systems.

It is known in the art that learning experiences are purchased and performed in increments of programs, courses and degrees which last from a few months to a few years.

It is known in the art that purchase methods for learning related offerings are managed by individual universities as well as admission aggregators like educational counselors as well as online application services. For an average learner, the first twenty or so years of learning involve dozens of learning related points of purchase like textbook retailers, schools, colleges, universities, training institutes, tutors, test/examination organizing authorities, Educational Boards or Professional Standards Authorities, recruiting organizations and the like.

A learner wishing to purchase and perform learning experiences comprising learning content and associated application services is restricted from purchasing and performing the same in micro increments of time and money.

The learner is also restricted from availing the modularity and flexibility of purchasing a microlearning stack of learning content and associated application services compatible with his profile and with each other by current learning management systems. The learner is also restricted from availing the modularity and flexibility of performing a microlearning stack of learning content and associated application services compatible with each other and available at the same time by current learning management systems.

A learner is restricted from purchasing and performing the most up to date learning applications with their chosen compatible tutors, tools, at a learning facility of their choice irrespective of their inclusion in the curriculum of their board by current learning management systems.

The learner is restricted from combining compatible learning offerings like tutor services, learning facility access, learning tools, aids or materials into a personalized learning stack for a specific small unit of learning content and purchasing the same at a centralized point of purchase without fear of incompatibility, inconsistency or discontinuity by current learning management systems.

The learner is restricted from managing the purchase, delivery and performance of learning content and services into micro increments of individual hours and individual learning applications and not courses or programs by current learning management systems.

A learning management system administrator is restricted from efficiently managing a microlearning ecosystem comprising a plurality of entities with diverse demographics playing a plurality of roles (like learning users, tutoring users, learning content application authoring users, learning content application template developing users, learning content application translating users, learning content application certifying users, learning facility administering users, learning tools supplying users, learning visits organizing users, recruiting users as well as funding users) and associated with a particular microlearning service stack or particular unit of learning content or particular unit of learning service by current learning management systems.

The learning management system administrator is restricted from efficiently managing the purchase and performance compatibility and performance availability of diverse units of learning content and associated application services across multiple geographical domains, mediums of instruction and for different learner demographics by current learning management systems.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 is a modular learning environment 100 including a modular learning system 144 according to one embodiment.

FIG. 2 is a block diagram of a modular learning system 144 according to one embodiment.

FIG. 3A is a block diagram of a learning application 300 according to one embodiment.

FIG. 3B is a block diagram of a learning application 300 according to an alternative embodiment.

FIG. 4 is a micro learning purchase management module 400 according to one embodiment.

FIG. 5 is a microlearning performance management module 500 according to one embodiment.

FIG. 6 is a flow diagram 600 of a method for a learning user to purchase a learning application and microlearning application services stack according to one embodiment.

FIG. 7 is a flow diagram 700 of a method for a learning user to perform a learning application and microlearning application services stack according to one embodiment.

FIG. 8 illustrates components of an example machine 800 able to read instructions from a machine-readable medium and execute them in a processor (or controller) according to one embodiment.

### DETAILED DESCRIPTION

The Figures (FIGS.) and the following description relate to preferred embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

### Configuration Overview

A system and method of managing the purchase and performance of a learning application and associated application services stack is provided. A modular learning system 144 stores and manages a plurality of learning applications. For example, a learning application may relate to learning to swim, learning a level of mathematics, or learning a martial art. The learning application may relate to fact-based lesson, such as a history lesson, to a performance-based skill, such as swimming, or to a creative skill such as writing and directing a play. The learning applications comprise learning content and metadata for determining compatibility of the learning application with users and learning services required for performing the learning application. Prior to purchasing and using a learning application, a learning user is verified as compatible for receiving and using the learning application. Learning applications are described in further detail below.

Learning users purchasing a learning application may select learning service providers compatible with the particular learning application in order to learn the content of the learning application. Such learning services may include access to a learning facility, learning tools, learning aids, learning materials, tutoring services, testing services and other services. Each of these learning services may be selected by the learning user 102 and may be provided by a different entity. Each learning application comprises a plurality of kinds of application metadata in addition to the instructional content and associated media for a particular topic or subject. The instructional content and media of each learning application may comprise a specific unit of instruction for a particular portion of knowledge or a skill, and may vary widely in scope. The learning user's 102 relationship with the various application service providers is managed through modular learning system 144 with respect to individual learning applications. Each of the learning services is also associated with metadata which may describe aspects of the application services, application service availability, learning users compatible with the application services, schedules, and other aspects of the application services. This metadata relating to the learning services is described in further detail below.

For example, a learning user 102 using the modular learning system 144 may obtain, in micro increments of time and money, tutoring services from a particular tutoring user 112, learning applications from a content application authoring user 104, learning tools, aids or materials from a learning tools supplying user 118, learning visits from a learning visits organizing user 114, learning facility access to a learning facility 132, learning workshop access from a learning workshop organizing user 116 and may wish to seek placement or recruitment at another organization through a user registered on the system as a recruiting user 120. The modular learning system 144 enables each of these entities to provide services to the learning user 102 using the learning applications. As such, the modular learning system 144 enables the learning user 102 to identify learning content applications the learning user 102 is interested in, and connecting the learning user 102 with application service providers that can provide distinct application services associated with those learning content applications.

Figure (FIG.) 1 is a modular learning environment 100 including a modular learning system 144 according to one embodiment. Modular learning system 144 operates in modular learning environment 100 and communicates with a plurality of user devices 140 over a network 142. The user devices 140 are operated by a plurality of kinds of users in the learning environment. The user devices 140 may comprise any of a variety of computing devices, such as a desktop computer, a laptop, a mobile device, a tablet computer, a set-top box, a kiosk, interactive television, gaming console, and other computing platforms suitable for communicating with modular learning system 144. The modular learning system 144 provides a system for managing curricula, learning facilities, standardized tests, learning applications, tutors, and other components of a learning experience in micro increments of time and money. The modular learning system 144 enables the various users to communicate with other users in a learning environment and provide services to learning user 102. The network 142 includes a wireless area network, a local area network, a General Packet Radio Service (GPRS) network, an Enhanced Data for Global Evolution (EDGE) network, a 3g network, a 4g long term evolution network or any general telecommunications network and the like. The user devices 140 are connected to the modular learning system 144 via the network 142.

Modular learning system 144 allows a learning user 102 to manage the purchase and performance of each component of a single microlearning service stack for a learning application (e.g., Breaststroke) or a group of learning applications (e.g., Breaststroke, Freestyle, Butterfly and Swimming Safety). Tutor access, such as access to a swimming instructor may be purchased in various increments, such as in hours. Learning content applications such as a breaststroke application with attached instructional media and other data may be purchased in timed access quantities or may be permanently purchased. Learning facility access such as an Olympic Sized Swimming Pool may be purchased in increments of hours or learning application performances such as ten laps. Learning tools or materials such as Swimming Goggles may be purchased as well. Each of these components may be separately purchased and interacted with through an interface displayed on user device 140. In case of a learning performance which can be completed on the user device 140 itself, the learning application content is not only purchased and managed, but also performed, through an interface displayed on the user device 140. A learning user 102 may manage the purchase and performance of groups of microlearning performances in the form of learning visits and learning workshops, through an interface displayed on user device 140. Learning user 102 may manage an individual learning identity (or learning profile) and offer details of micro learning application performances completed by the learning user, as well as the personal learning metrics, scores, and reviews. This learning identity may be provided to recruiting users for the purpose of placement.

The modular learning system 144 manages, regulates and supervises the purchase, sale, preview, performance and review of a plurality of micro learning applications, each comprised modularly of a tutoring service, a learning application, learning facility access, and/or learning tools or infrastructure access, a learning visit, and/or a workshop as described in further detail below. The modular learning system 144 manages transactional and functional relationships between users of the modular learning system 144. These various users interact with the modular learning system 144 to modify learning applications and provide learning services as described below.

The modular learning system 144 may enable various other users including but not limited to tutors, authors, tool/material suppliers learning application template developers, translators, certifying user, learning facility administrators, learning event organizers, recruiters, and funders to modularly manage at least one of micro tutoring services associated with specific learning applications, micro learning content applications, micro learning application templates, translation of micro learning content applications, certification of micro learning content applications, access to learning facilities, access to learning workshops, organization of learning visits associated with specific learning applications, supply of tools, aids and/or materials, recruitment services, as well as granular funding services.

The modular learning system 144 enables a tutoring user 112 to provide microtutoring services to learning user 102. Tutoring user 112 are typically individuals with credentials or other knowledge in the area of learning applications. The tutoring user 112 may associate themselves with particular pieces of content to and may indicate qualifications to teach each learning application, as is described further below. The modular learning system 144 manages the sale of micro tutoring services and associated tutoring user 112 with specific learning applications to learning user 102. Tutoring user 112 assist the learning user 102 with learning the subject matter of the learning application. The tutoring user may provide tutoring to the learning user 102 by meeting the learning user 102 in person to assist the learning user 102 in performing the learning application. As such, the modular learning system 144 facilitates the meeting and communication of tutors and learners. Tutoring user 112 may also provide learning performance data to the modular learning system 144. The learning performance data may indicate, for example, the level of the learner's mastery or proficiency through scoring or other metrics for reviewing performance at a learning performance task. The tutoring user 112 provides input to the modular learning system 144 using a plurality of learning applications through an interface displayed on the tutoring user's 112 user device 140.

The modular learning system 144 enables a learning application authoring user 104 to manage the drafting, editing, testing, publishing, sale and updates of learning content in applications through an interface displayed on user device 140. That is, the learning application authoring user 104 authors individual pieces of learning content which may be purchased and used by a learning user. For example, a learning application authoring user 104 may create instructional content for learning the backstroke. The instructional content may comprise instructions and multimedia, as well as directions for the learning user 102 to practice aspects of the backstroke in a suitable pool. The learning application authoring user 104 may use a pre-existing application template to create the learning application.

The modular learning system 144 enables a learning application template developing user 110 to create learning templates for use in creating learning applications. The learning application templates provide a framework for creating various types of learning applications. For example, learning application templates may comprise a quiz, simulation, role play, experiment, multimedia material, and other types of learning frameworks. The learning application template developing user 110 may manage the development, testing and sale of the learning application templates to learning content application authoring users 104 through an interface displayed on a user device 140.

The modular learning system 144 enables a learning application translating user 106 to manage the translation and translation updates of learning content in applications and sale of such services to microlearning content application authors through an interface displayed on a user device 140. The translations are provided to the modular learning system 144 and may be stored with the corresponding learning application to enable providing instructions to learning users 102 in a variety of languages.

The modular learning system 144 enables a learning application certifying user 108 to certify various learning applications according to standards applied by the certifying user 108. Such certifying users may include boards of education at various levels, universities, professional standards groups, and other certification authorities. Certifying users 108 may or may not be formal institutions. For example, a certifying user may include a company establishing a set of learning applications to prepare a candidate for a job with the company. The certifying user 108 manages the certification of each learning content application as a part of their respective curricula or syllabi and manages the sale of such certification services to learning content application authoring users, through an interface displayed on user device 140.

The learning facility 132 facilitates the performance of specific learning applications available on the modular learning system 144. Learning facilities 132 may comprise any location suitable for performing types of learning applications. For example, learning facilities 132 may comprise an athletic club, a chemistry lab, a science lab, a university, a library, or a tutor's home. In some embodiments, the modular learning system 144 enables a facility administering user 124 to determine the compatibility of various learning applications which can be performed within learning facility 132 by picking the learning infrastructure available in the learning facility and associating the learning facility 132 with each learning application (e.g., Breaststroke) compatible with the learning infrastructure (e.g., Olympic sized Swimming Pool). In one embodiment, rather than expressly associating the learning facility with individual learning applications, the learning facility administering user 124 indicates to the modular learning system 144 the specific infrastructures and amenities available at the learning facility 132. In this embodiment, the modular learning system 144 enables a learning user 102 or learning application authoring user 104 to identify a learning facility 132 which is compatible with the learning application based on the infrastructure available at the learning facility 132. The modular learning system 144 may also identify compatible learning facilities based on metadata associated with the learning application and the infrastructure indicated by the learning facility administering user 124.

The learning facilities 132 may comprise a variety of types of learning facilities, such as an independent learning facility, institutional learning facility, workplace learning facility, and temporary learning facility. The modular learning system 144 enables an administrator 124 of an independent learning facility owned, managed or franchised by the modular learning system 144 to manage the sale of learning facility access for performances of specific microlearning applications as well as sale of learning tools and materials (e.g., sulphuric acid or swimming goggles) or access to the same in micro increments of time and money ($6/hour or $5/learning application performance) depending on multiple factors like the learning infrastructure to be accessed (e.g., Swimming Pool, Computers, Chemistry Lab), number of hours of access, and the like, through an interface displayed on a user device 140.

The modular learning system 144 enables an administrator 124 of an institutional learning facility like a preschool, school, college or university (e.g., Bangalore University) associated, partnered or linked with the modular learning system 144 to, in addition to managing the sale associated with the independent learning facility (e.g., learning facility access for performances of specific microlearning applications), manage the learning performances of a plurality of learners (students or outsiders) across a plurality of learning applications available on the system (with the learning user's explicit consent), optionally delegated to a plurality of teachers, professors, lecturers or coaches registered as tutoring users 112 on the modular learning system 144, through an interface displayed on a user device 140.

The modular learning system 144 enables an administrator 124 of a workspace learning facility associated, partnered or linked with the modular learning system 144 to, in addition to managing the sale associated with the independent learning facility (e.g., learning facility access for performances of specific microlearning applications), manage the learning performances of a plurality of learners (employees) across a plurality of learning applications available on the system (with the learning user's explicit consent), optionally delegated to a plurality of Human Resource Managers, Trainers and/or immediate superiors, registered as tutoring users 112 on the modular learning system, through an interface displayed on a user device 140.

The modular learning system 144 enables an administrator 124 of a temporary learning facility (e.g., a Cricket Ground available for net practice on Saturdays and Sundays from 6 am to 12 midnight) to, in addition to managing the sale associated with the independent learning facility (e.g., learning facility access for performances of specific microlearning applications), manage the hours of accessibility to the designated learning facility, through an interface displayed on a user device 140. In addition to managing the sale and performance of micro learning applications, an administrator of an independent, institutional, workspace, or temporary learning facility may manage the modular purchase of learning infrastructure (e.g., chemistry equipment, computers, cricket stumps) as well as learning tools, aids and materials (e.g., sulphuric acid, swimming goggles, cricket bat) from the modular learning system provider or a third party, topic wise, subject wise, location wise or otherwise based on the learning applications intended to be offered in the designated learning facility, through an interface displayed on a user device 140.

The modular learning system 144 enables a learning visit organizing user 114 to manage the organization of learning visits, and the sale of learning visits to learning users 102. The learning visit organizing user 114 may also associate a learning visit with compatible microlearning applications. Such learning visits may comprise, for example, a visit to a factory or industrial area, a museum, or a trip to a city. The learning visit organizing user 114 may associate the learning visit with learning applications and manage the learning performances during the learning visits. The management of performances of associated learning applications may be optionally provided by tutoring users 112. The learning visit organizing user 114 communicates with the modular learning system 144 through an interface displayed on a user device 140.

The modular learning system 144 enables a learning workshop organizing user 116 to manage the organization of workshops available to learning users 102. A workshop comprises a plurality of specific microlearning applications to be performed in the workshop, and a sequence of the microlearning applications to be performed at the workshop. The workshop may also specify learning tools, a designated learning facility, and a tutoring user or tutoring users to perform the workshop. As such, the workshop user organizes performance and components of learning applications to be performed together with a group of learning users 102. The learning workshop organizing users 116 also manage the sale of such microlearning workshop access and manage the learning performances for a plurality of learners. The learning workshop organizing users communicate with the modular learning system 144 through an interface displayed on a user device 140.

The modular learning system 144 enables a learning tools supplying user 118 to provide learning tools and materials such as chemicals, biology samples, computer software, and other materials for use with learning applications to learning users 102. The learning tools supplying user 118 manages the organization and sale of the learning tools and materials (or optionally, access to the same) to learning users and administrators of learning facilities 132. The learning tools supplying user 118 may also associate learning tools with particular learning applications stored on modular learning system 144. Alternatively, the learning tools supplying user 118 may designate the tools available and the modular learning system 144 may determine which learning applications may require the tools provided by the learning tools supplying user 118. The learning tools supplying user communicates with the modular learning system 144 through an interface displayed on a user device 140.

The modular learning system 144 enables a recruiter 120 of learning users 102 to manage the recruitment of learning users 102 through the modular learning system 144. The recruiter 120 may view and filter learning users 102 by specific learning applications performed on the system, scores, metrics and reviews generated in relation to the learning applications performed by learning users 102. The recruiter may access and filter learning users 102 based on demographic data like the language used in performing the learning application. Recruiting user 120 may also operate as a certifying user 108 to certify particular learning applications that may be desirable to the recruiting user 120. The recruiting user may use the certified application as a filter prior considering learning users for a position. The recruiting user 120 manages recruiting access to the modular learning system 144 through an interface displayed on a user device 140.

The modular learning system 144 enables a funding user 122 of learning users 102 to provide funding and scholarship funds and other support to learning users 102. Such funding users 122 may comprise a parent, sibling, friend, spouse, relative, university, employer, or scholarship/grant offering institution. The funds may be provided for the funding of specific learning users or of specific learning applications, or of specific microlearning goods and services associated with the specific learning applications, in small increments, through an interface displayed on a user device 140.

Although the modular learning environment 100 is described as being composed of various, user devices (e.g., personal computer), a network (e.g., internet, intranet, world wide web), learning facilities (e.g., an Independent Learning Facility, an Institutional Learning Facility), it would be appreciated by one skilled in the art that fewer or more kinds of users (e.g., a Learning Application Fact Checking User, a Web Based Offsite Tutoring User), user devices (e.g., a mobile phone device, a portable gaming console device, a tablet device, a learning console device, gaming console device or server device attached to a television or other screen), networks (e.g., an intranet at a preschool, school, college, university, educational board, professional standards authority, coaching/tuition class; a social or professional network; an intranet at a company, HR department, training department and at a training organization) and learning facilities may comprise the modular learning environment 100, with the present disclosure still falling within the scope of various embodiments.

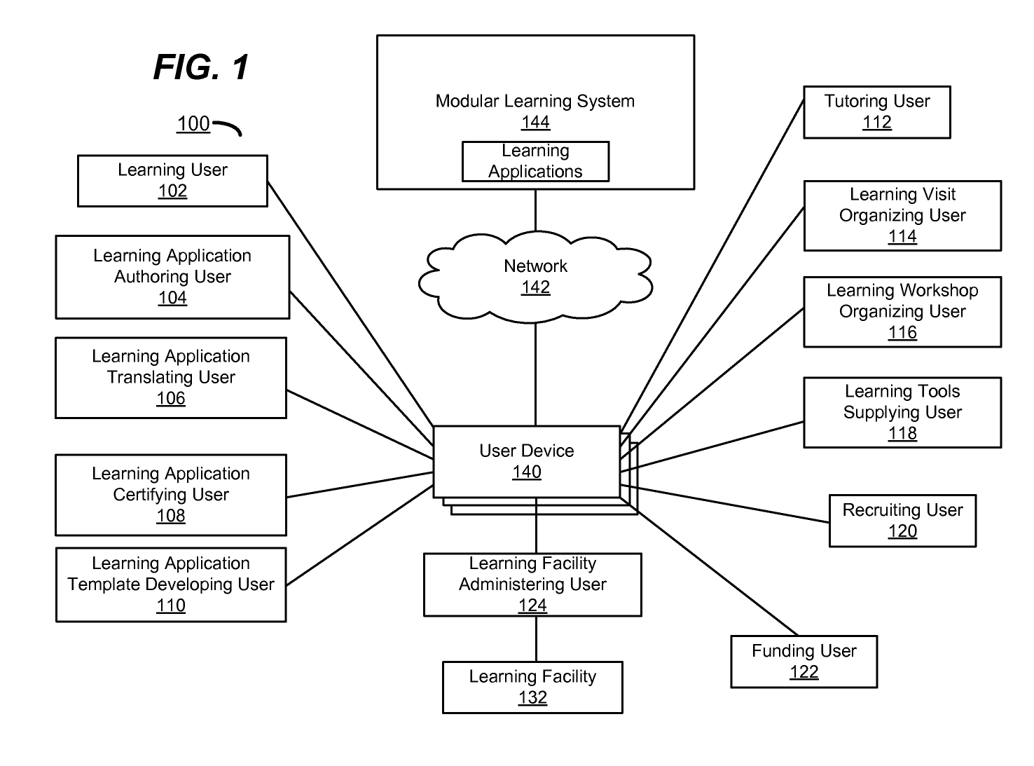

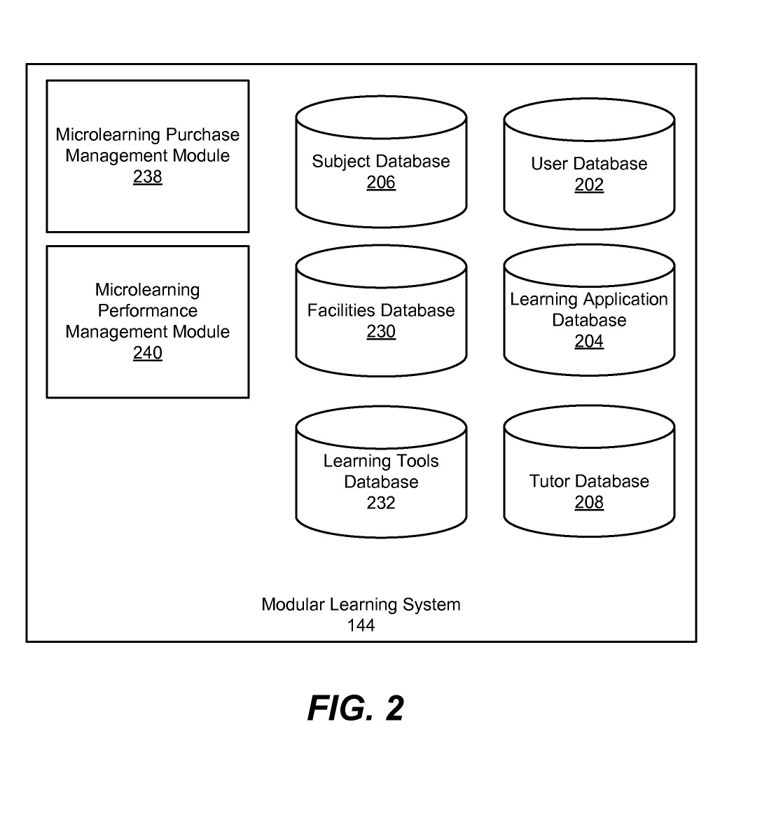

FIG. 2 is a block diagram of a modular learning system 144 according to one embodiment. The modular learning system 144 includes a variety of databases and modules for providing learning applications and learning services to users of the modular learning system 144. The modular learning system 144 maintains learning applications in a learning application database 204. The learning applications are sold to users along with one or more microlearning services using the purchase management module 238. Performance of learning applications is enabled by with performance management module 240. Additional components of the modular learning system 144 are described below.

A user database 202 is configured for receiving, storing, updating and retrieving a plurality of data fields of each user, such as the user's name, address, and contact details. Depending on the user's role in the modular learning system 144, the user database 202 maintains additional information on the user. For example, for a learning user 102, the user database 202 maintains learning history outside the modular learning system 144, learning application performance history on the modular learning system 144, purchase history of learning applications as well as purchase history of a host of related microlearning purchase items like, for example, timed access to learning facility 132, timed access to tutor 112, and purchase of access to a learning tool from learning tools database 232. In some embodiments, the data fields are used to determine purchase compatibility using purchase management module 238 and to determine performance compatibility using performance management module 240.

The user database 202 may maintain information about each type of user based on the user's role in the system. The user information may be stored in a plurality of databases, each database associated with a user role, or the user roles may be stored in a single user database 202. For example, the additional user roles include learning application authoring users, learning facility administering users, learning visit organizing users, learning facility administering users, and other types of users of the modular learning system 144.

In one embodiment, a distinct Learning User Database is configured for receiving, storing, updating and retrieving a plurality of data fields of each learning user 102, comprising the learning user's name, address, contact details as well as learning related data fields like learning history outside the modular learning system 144, learning application performance history on the modular learning system 144, purchase history of learning applications as well as purchase history of a host of related microlearning purchase items like, for example, access to learning facility 132, access to tutor 112, and purchase of access to an exemplary learning tool. In one embodiment, a distinct Learning Application Authoring User Database is configured for receiving, storing, updating and retrieving a plurality of data fields of each learning application authoring user, say, user 104. In one embodiment, a distinct Independent Learning Facility Administering User Database is configured for receiving, storing, updating and retrieving a plurality of data fields of each independent learning facility administering user, say, user 124. In one embodiment, a distinct Learning Tools Supplying User Database is configured for receiving, storing, updating and retrieving a plurality of data fields of each learning tools supplying user, say, user 118. In one embodiment, a distinct Learning Visit Organizing User Database is configured for receiving, storing, updating and retrieving a plurality of data fields of each learning visit organizing user 114. In one embodiment, a distinct Learning Application Translating User Database is configured for receiving, storing, updating and retrieving a plurality of data fields of each learning application translating user, say, user 106. In one embodiment, a distinct Learning Application Certifying User Database is configured for receiving, storing, updating and retrieving a plurality of data fields of each learning application certifying user, say, user 108. In one embodiment, a distinct Learning Application Template Developing User Database is configured for receiving, storing, updating and retrieving a plurality of data fields of each learning application template developing user, say, user 110. In one embodiment, a distinct Learning Workshop Organizing User Database is configured for receiving, storing, updating and retrieving a plurality of data fields of each learning workshop organizing user, say, user 116. In one embodiment, a distinct Recruiting User Database is configured for receiving, storing, updating and retrieving a plurality of data fields of each recruiting user, say, recruiting user 120. In one embodiment, a distinct Funding User Database is configured for receiving, storing, updating and retrieving a plurality of data fields of each funding user, say, funding user 122.

In one embodiment, a distinct Institutional Learning Facility Administering User Database is configured for receiving, storing, updating and retrieving a plurality of data fields of each, institutional learning facility administering user, say, user 124. In one embodiment, a distinct Workspace Learning Facility Administering User Database is used to is configured for receiving, storing, updating and retrieving a plurality of data fields of each workspace learning facility administering user, say, user 124. In one embodiment, a distinct Temporary Learning Facility Administering User Database is configured for receiving, storing, updating and retrieving a plurality of data fields of each temporary learning facility administering user, say, user 124. In one embodiment, a distinct Learning Facility Database is configured for receiving, storing, updating and retrieving a plurality of data fields of a plurality of kinds of learning facilities, say, facility 132, as received from a plurality of kinds of learning facility administering users, say, user 124. In one embodiment, a distinct Learning Visits Database is configured for receiving, storing, updating and retrieving a plurality of data fields of each learning visit from the respective learning visit organizing user, say user 124. In some embodiments, the data fields of the databases in the above embodiments are used to determine purchase compatibility using purchase management module 238 and to determine performance compatibility using performance management module 240.

In an embodiment, the plurality of user databases 202 may be a learning user database, a learning application authoring user database, a learning application translating user database, a learning application certifying user database, a learning application template developing user database, an independent learning facility administering user database, an institutional learning facility administering user database, a workspace learning facility user database, a temporary learning facility administering user database, a tutor database, a learning visit organizing user database, a learning workshop organizing user database, a learning tools supplying user database, a recruiting user database, and a funding user database.

The learning application database 204 is configured for receiving, storing, updating and retrieving all the learning application metadata of all learning applications whose purchase is managed through the module 238. Optionally, all purchase related metadata of said learning application, like number of copies accessed per day, segmented by location, language, learning facility, user device, as well as other learning related purchase analytics metadata that may be generated during the purchase process may be received, stored, and updated by the microlearning purchase management module in the learning application database 204.

In one embodiment, said database 204 is configured for receiving, storing, updating and retrieving all the learning application metadata of all learning applications whose performance is managed through the module 240. Optionally, all performance related metadata of the said learning application, like number of copies performed per day, segmented by location, language, learning facility, user device, as well as other learning related performance analytics metadata that may be generated during the performance process may be received, stored, and updated by the microlearning performance management module in the learning application database 204.

A subject database 206 is configured for receiving, storing, updating and retrieving a plurality of data fields of each subject linked or tagged to each learning application 300 in Subject Metadata 312. The subject database 206 provides a categorization system for the learning applications and enables learning application authoring users, like user 104, to categorize learning applications as belonging to one or more subjects by associating them with one or more subjects, such subjects then stored in subject metadata 312 of each authored learning application 300. The subject database 206 also allows users to search for learning applications according to particular subjects using the subjects associated with the learning applications. For example, a tutoring user 112 with a mathematics specialty may search the learning applications using the subject database 206 to identify mathematics learning applications for the tutor to associate his services with.

A tutor database 208 is configured for receiving, storing, updating and retrieving a plurality of data fields of each tutoring user, comprising the tutoring user's name, address, contact details, as well as learning related data fields like learning users to whom microlearning services have or are being provided, performance data and performance review data for the tutoring services, tutoring history outside the modular learning system 144, and remittance history. In some embodiments, the data fields are used to determine purchase compatibility using purchase management module 238 and to determine performance compatibility using performance management module 240.

A learning facility database 230 is configured for receiving, storing, updating and retrieving a plurality of data fields of a plurality of kinds of learning facilities such as learning facility 132 as received from learning facility administering users 124. In some embodiments, the data fields are used to determine purchase compatibility using purchase management module 238 and to determine performance compatibility using performance management module 240.

A learning tools database 232 is configured for receiving, storing, updating and retrieving a plurality of data fields of each learning tool or material from each learning tools supplying user 118. In some embodiments, the data fields are used to determine purchase compatibility using purchase management module 238 and to determine performance compatibility using performance management module 240.

Each of these databases, such as the tutor database 208, facilities database 230, and learning tools database 232, may also include information relating to purchase and performance compatibility. For example, a tutor in the tutor database may specify the tutor is only willing to teach students aged 30-40, or a learning facility may indicate it is only willing to allow entry to learning users who are a member of the facility.

A purchase management module 238 is configured for managing the purchase of learning applications and associated application services as a microlearning stack by the learning user 102.

A performance management module 240 is configured for managing the performance of learning applications and associated application services as a microlearning stack by the learning user 102.

In one embodiment, the tutor database, learning facilities database, tools database and other application services databases form a single consolidated application services database in modular learning system 144.

Although the modular learning system 144 is described as being composed of various components like databases and modules, the modular learning system 144 may comprise fewer or more databases, modules, and other components. For example, the modular learning system 144 may include a Learning Application Genre Database, a Locational Learning Facility Price Range Database, a Learning Workshop Database, a Multilingual Dictionary Database, a Concept Tags Database, a Learning Objectives Database, a Learning Outcomes Database, a Microtutoring Services Database, and a Skill and Ability Tags Database. The modular learning system 144 may also include an Age Compatibility Module, a Learner Ranking Module, a Tutor Ranking Module, a Learner Billing Module, a Tutor Remittance Module, a Profile Management Module, a User Roles Management Module, a Learning Tools Management Module, a Learning Facility Management Module, Metadata Management Module, a Notification Module, a Recruitment Module, a Funding Module, a Map Module, a Learning Application Template Programming Interface Module, an Age Compatibility Module, a Learning Application Template Programming Module, an User Databases Module, a Purchase Items Database Module, or a Translation Interface Module, with the present disclosure still falling within the scope of various embodiments. In some embodiments, an individual or group may play a plurality of user roles on the modular learning system, (e.g., tutoring user learning new applications as a learning user through another tutoring user, a learning application authoring user translating the authored application or developing the application template), with the present disclosure still falling within the scope of various embodiments.

In various embodiments the modular learning system 144 may be any of a web application, a mobile application, or an embedded module or subsystem of a social networking environment, a learning content management system, a learning management system, a professional networking environment, an electronic commerce system, an electronic payments system, a mobile operating system, a computer based operating system, or of a tablet based operating system, with the present disclosure still falling within the scope of various embodiments.

In one embodiment, a distinct roles management module is configured for managing and authorizing different roles associated with the various users of the modular learning system 144 and in the respective user databases. For example, the roles management module may provide distinct feature tabs and functionalities to each user based on the role associated with him or her. It can be noted that, the roles management module may enable a user to have one or more roles for accessing the modular learning system 144. For example, a tutoring user can avail the functionality and interface tabs of a learning user and also of a translating user if authorized by the modular learning system 144.

In one embodiment, a distinct metadata management module is configured for managing metadata associated with a plurality of specific learning applications, like learning application 300. In one embodiment, the metadata management module is configured for receiving, storing, updating and retrieving various types of metadata associated with each learning application 300 in the learning application database 204. In another embodiment, the metadata management module is configured for receiving and storing updated metadata of a specific learning application 300 in database 204 at regular intervals of time as updated by different users in authorized user roles and retrieving the required metadata when requested by the purchase management module 238 and the performance management module 240 for determining compatibility and performance compatibility of requested microlearning service stack respectively. In yet another embodiment, the metadata management module enables various users of the modular learning platform to update metadata associated with specific learning applications in the learning application database according to their user role.

It is appreciated that, in some embodiments, various databases like 202, 204, 206, 208, 230, and 232, modules 238 and 240 as well as the databases, modules, components and engines of the above embodiments may be stored in the form of machine readable instructions in the memory of the modular learning system 144 and executed by a processor of the modular learning system 144 to perform one or more embodiments disclosed herein. Alternatively, the various databases like 202, 204, 206, 208, 230, and 232, modules 238 and 240 as well as the databases, modules, components and engines of the above embodiments may be implemented in the modular learning system in the form of an apparatus configured to perform one or more embodiments disclosed herein.

In an embodiment, the modular learning system 144 may comprise fewer or more user, For Example, a learning user, a learning application authoring user, a learning application translating user, a learning application certifying user, a learning application template developing user, an independent learning facility administering user, an institutional learning facility administering user, a workspace learning facility user, a temporary learning facility administering user, a tutoring user, a learning visit organizing user, a learning workshop organizing user, a learning tools supplying user, a recruiting user, or a funding user.

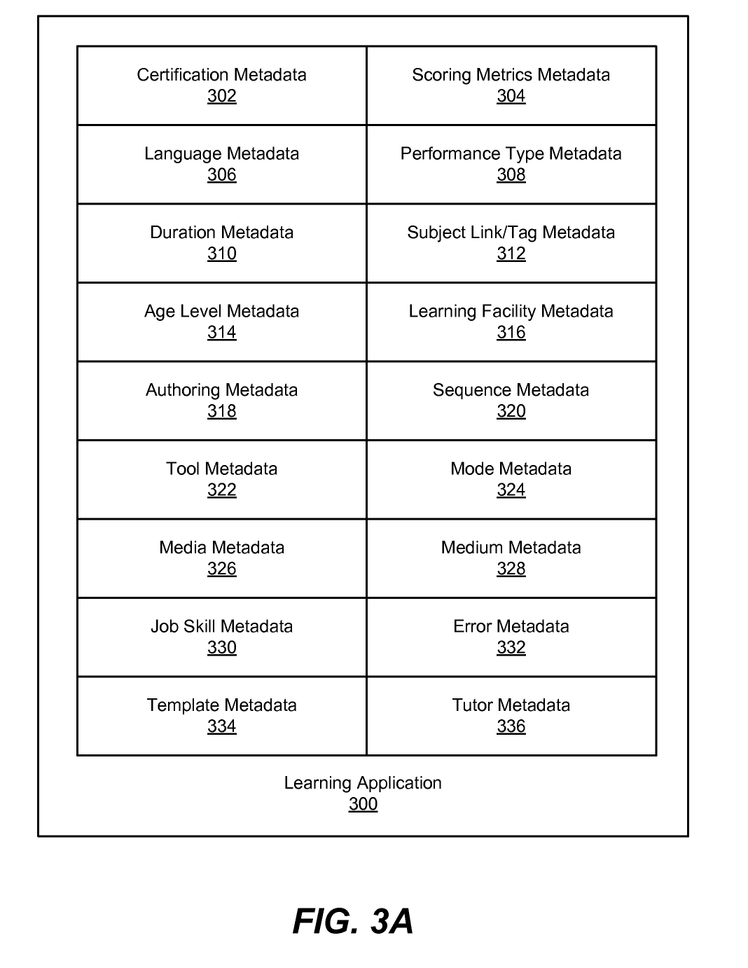

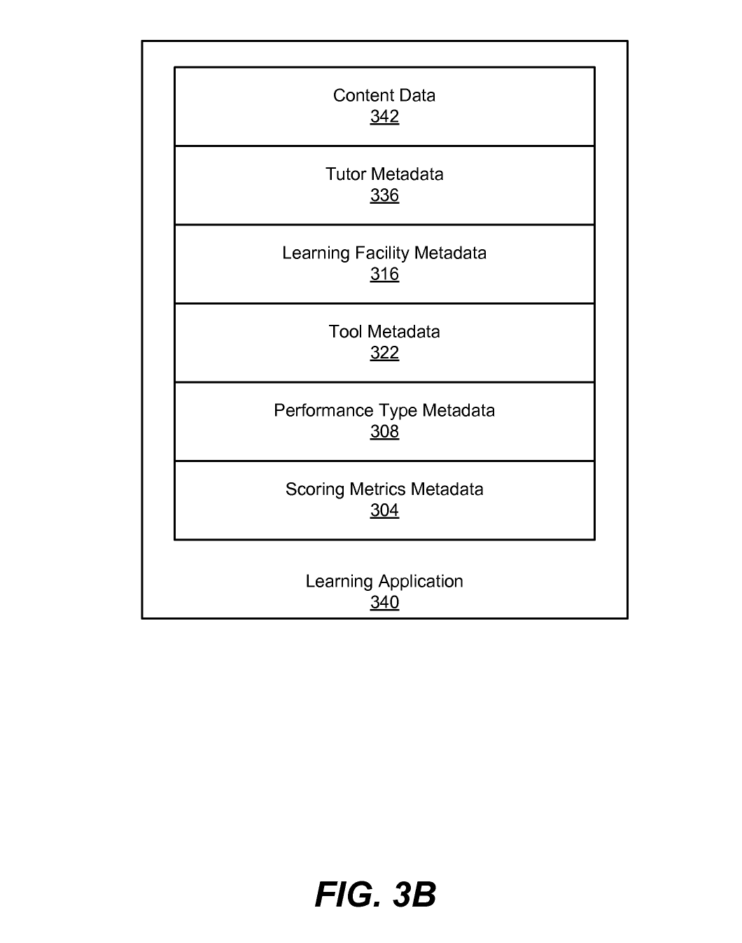

FIG. 3A is a block diagram of a learning application 300, according to one embodiment. Each learning application 300 comprises a plurality of kinds of application metadata in addition to the instructional content and associated media for a particular topic or subject. The instructional content and media of each learning application 300 may comprise a specific unit of instruction for a particular portion of knowledge or a skill, and may vary widely in scope. The learning application 300 may be very narrow in scope, such as “treading water” or may be broad in scope, such as “overview of world history”, depending on the authoring process of learning application authoring user 104. The learning application 300 could indicate a theoria (to think, a theory based application using primarily memory, reasoning, logic) performance type or a praxis performance type (to do, a practical performance type or a poeisis performance type). The learning application 300 may comprise metadata indicating associated application services for purchasing or performing the learning application 300 like tutor metadata 336, tools metadata 322 and learning facility metadata 316. In one embodiment, the learning application 300 may be requested for purchase or performance with associated application services as a microlearning service stack, wherein the application services comprise of access to tutoring user 112, access to a learning tool from learning tools database 232 and access to a learning facility from facilities database 230. For example, the media metadata 326 of a learning application 300 provided by learning application authoring user 104 may specify instructions for learning how to swim a breaststroke, but the media metadata 326 does not typically specify individual pools i.e. learning facilities to perform the learning application or tutors to coach and review the performance. Rather, the application services metadata like tutor metadata 336, tools metadata 322 and learning facility metadata 316 indicates tutors, tools, and facilities which the learning user may choose to perform the learning application's instructions.

The Certification Metadata 302 is used to receive, store, retrieve, display and update certification history as well as live certifications of the said learning application 300, including, for example, a certification from educational board 108 and another educational board in another state, present as a certifying user in database 202 or a distinct certifying user database. In some embodiments, the said certification metadata is also used to determine purchase compatibility in the microlearning purchase management module 238 through learning application database 204 and to determine performance compatibility in the microlearning performance management module 240 through learning application database 204.

The Scoring Metrics Metadata 304 is used to receive, store, retrieve, display and update a plurality of metrics for quantitative and qualitative scoring as defined and updated for learning application 300 by learning content application authoring user 104. In some embodiments, the quantitative scoring of each metric is conducted during the performance by a dedicated module within the learning application 300 itself, while in other embodiments of a performance, especially a non-screen based praxis or poeisis performance, the quantitative and optionally, qualitative score for each metric is received through a user device 140 from the learning user 102 and/or the tutoring user 112. In some embodiments, the scoring metrics metadata is also used to determine purchase compatibility in the microlearning purchase management module 238 through learning application database 204 and to determine performance compatibility in the microlearning performance management module 240 through learning application database 204.

The Language Metadata 306 is used to receive, store, retrieve, display and update a plurality of translations of all user viewable application metadata for learning application 300 translated by, for example, learning application translating user 106 into Bengali, comprising of media metadata 326 like instructional text, subtitles to audio and video instructions, and all other linguistic content for the preview, performance and review of learning application 300 by learning user 102 and preview and review of the said learning performance by tutoring user 112. In some embodiments, metadata 306 further comprises translations in at least one other language, of performance type metadata 308, duration metadata 310, subject links and tags metadata 312, age level metadata 314, learning facility metadata 316 authoring metadata 318, sequence metadata 320, tool metadata 322, mode metadata 324, medium metadata 328 and job skill metadata 330. In some embodiments, the language metadata is also used to determine purchase compatibility in the microlearning purchase management module 238 through learning application database 204 and to determine performance compatibility in the microlearning performance management module 240 through learning application database 204.

The Performance Type Metadata 308 is used to receive, store, retrieve, display and update the performance type of the said learning application 300. For example, the metadata 308 could indicate a theoria (to think, a theory based application using primarily memory, reasoning, logic, like a ‘Biomechanics of Swimming’ Pop Quiz) performance type or a praxis performance type (to do, a practical performance type like an ‘800 m Freestyle Swim as per Olympic performance guidelines’ or a poeisis performance type (to make, a creation oriented performance type like a ‘5 minute Synchronized Swimming Choreography’), such that the learning user is already aware of the task or performance type before purchasing and performing the said learning application 300. In some embodiments, the performance type metadata is also used to determine purchase compatibility in the microlearning purchase management module 238 through learning application database 204 and to determine performance compatibility in the microlearning performance management module 240 through learning application database 204.

The Duration Metadata 310 is used to receive, store, retrieve, display and update the suggested duration of the said learning application 300. In some embodiments, the said metadata 310 indicates a fixed duration like, 15 minutes, or 30 minutes, or 1 hour, while in other embodiments, the said metadata indicates a variable duration with, optionally, a predetermined minimum or maximum duration depending on the duration metadata set by the learning application authoring user 104. In some embodiments, the duration metadata is also used to determine purchase compatibility in the microlearning purchase management module 238 through learning application database 204 and to determine performance compatibility in the microlearning performance management module 240 through learning application database 204.

The Subject Metadata 312 is used to receive, store, retrieve, display and update a plurality of subject links and tags attached to the said learning application 300 by the learning content application authoring user from among the subject links and tags present in the Subject Database 206. In some embodiments, the subject links and tags are attached to specific concepts or terms within the Media Metadata 326. In some embodiments, the subject link/tag metadata is also used to determine purchase compatibility in the microlearning purchase management module 238 through learning application database 204 and to determine performance compatibility in the microlearning performance management module 240 through learning application database 204.

The Age Level Metadata 314 is used to receive, store, retrieve, display and update the suggested age level of the learning user 102 for performance of the learning application 300. In some embodiments, the age level is set as a minimum suggested age say, for example, 10+ by the learning content application authoring user 104. In other embodiments, a range of suggested learner ages is set by the learning application content authoring user 104. In some embodiments, the age level metadata is also used to determine purchase compatibility in the microlearning purchase management module 238 through learning application database 204 and to determine performance compatibility in the microlearning performance management module 240 through learning application database 204.

The Learning Facility Metadata 316 is used to receive, store, retrieve, display and update the suggested learning infrastructure required in a learning facility for performance of the said learning application 300. In some embodiments, such learning facilities and infrastructure (e.g., Olympic Sized Swimming Pool) required for the performance of the said learning application (e.g., 800 m Freestyle to Olympic Guidelines) is received and updated by the learning content application authoring user 104 by picking the same from a learning facility database 230 available on the modular learning system 144. In other embodiments the metadata 316 is received and updated by the administering user 124 of learning facility 132. In some embodiments, the learning facility metadata is also used to determine purchase compatibility in the microlearning purchase management module 238 through learning application database 204 and to determine performance compatibility in the microlearning performance management module 240 through learning application database 204.

The Authoring Metadata 318 is used to receive, store, retrieve, display and update the authoring metadata received by the learning content application author 104, including for example the name, signature, contact details, intellectual property disclaimer and other information of the said user or user group. In some embodiments, the metadata also includes metadata generated by the modular learning system 144 during the authoring user's editing process, including the version history, tracked changes and time stamps of edits and updates to the learning content application. In some embodiments, the metadata may also include citations to other learning content applications or other learning content application authoring users made by the said user 104.

The Sequence Metadata 320 is used to receive, store, retrieve, display and update the suggested sequence of performance of the learning application 300 relative to another learning application. The sequence metadata may indicate if the learning application should be performed before, after, instead of, or with another learning application by learning content application authoring user 104. The user 104 may wish for any learning user, say 102 to perform an advanced microbiology learning application 300 only after performing a corresponding beginner's microbiology learning application, irrespective of the learning user's age or quality of performance. In other embodiments, wherein the learning application authoring user is not the author of the suggested beginner's application, the user 104 may input a sequence suggesting to the learning user 102 to perform the learning application before or after a learning application authored by another learning application authoring user. In some embodiments, the sequence metadata is also used to determine purchase compatibility in the microlearning purchase management module 238 through learning application database 204 and to determine performance compatibility in the microlearning performance management module 240 through learning application database 204.

The Tool Metadata 322 is used to receive, store, retrieve, display and update the compatible tools or learning materials to the learning application 300. In some embodiments, the tool compatibility is received from and updated by the learning application authoring user 104 by accessing the tool database 232. In other embodiments, the tool compatibility is received and updated by the learning tools supplying user 118 by accessing the learning application database 204. In still other embodiments, the tool compatibility may be updated by the modular learning system 144 itself. In some embodiments, the tool metadata is used to determine purchase compatibility in the microlearning purchase management module 238 through learning application database 204 and to determine performance compatibility in the microlearning performance management module 240 through learning application database 204. In some embodiments, wherein the learning tool is a peripheral input device which can be connected to the user device 140 during the learning application performance (e.g., Electric Guitar attached to a user device 140 during an ‘Introduction to Hard Rock’ learning application) the Tool Metadata includes the compatibility to the user device 140. In other embodiments, wherein the learning material is not material to the user device 140, (e.g., Sulphuric Acid during a Chemistry Experiment) the Tool Metadata may not include any additional user device compatibility.

The Mode Metadata 324 is used to receive, store, retrieve, display and update the available modes of performance of the learning application. In some embodiments, the mode metadata is determined by the modes chosen by the learning content application authoring user from the learning application template chosen. In various embodiments, the learning application may comprise an individual learner performance mode, a learner plus learner cooperative performance mode, a learner versus learner competitive performance mode, a learner plus tutor cooperative performance mode, a learner versus tutor competitive performance mode, a limited plurality of learners (e.g., 4 learners) cooperative performance mode, a limited plurality of learners (e.g., 4 learners) competitive performance mode, a tutor plus limited plurality of learners (e.g., 9 learners) cooperative performance mode (a typical classroom mode). Although the Mode Metadata is described as being composed of various available modes as chosen by the learning application authoring user, various other modes (e.g., a limited plurality of learners vs. a limited plurality of learners competitive performance mode) may comprise the Mode Metadata 324 and still fall within the scope of various embodiments. In some embodiments, the various Media Metadata for the preview, performance and review screens for each mode of the same learning application and the sequence of the same (especially wherein the learning application 300 is performed by multiple users from the same user device and, optionally, by viewing the same display device) is received, stored, retrieved, displayed and updated in the Media Metadata 326. In some embodiments, the said mode metadata is also used to determine purchase compatibility in the microlearning purchase management module 238 through learning application database 204 and to determine performance compatibility in the microlearning performance management module 240 through learning application database 204.

The Media Metadata 326 is used to receive, store, retrieve, display and update text, image, audio, video, animation, links and other interactive elements of the learning content application as received and updated by the learning application authoring user 104 during the publishing and revision of the said learning content application 300. In other embodiments, the learning application Media Metadata may comprise the theoria, praxis or poeisis task or, optionally, plurality of tasks to be completed during the performance, their sequence, and, optionally, the learning outcomes and objectives of the same. In some embodiments, the media metadata is also used to determine purchase compatibility in the microlearning purchase management module 238 through learning application database 204 and to determine performance compatibility in the microlearning performance management module 240 through learning application database 204.

The Medium Metadata 328 is used to receive, store, retrieve, display and update the medium of access to the learning application preview, review and performance screen during the microlearning performance. For example, for a Beginner's Kathak Dancing microlearning Application, in addition to requiring a compatible learning facility and tutoring user, the learning application authoring user 104 or, optionally, modular learning system 144 may require the preview and review screen to be viewable only on a display device connected to a learning console user device or the display device of a computer device but not a mobile device screen to ensure an optimum learning experience. In another case, for a Kathak Quiz microlearning application, the learning application authoring user 104 or, optionally, modular learning system 144 may require the performance screen, preview screen and review screen to be viewable only on a mobile device screen but not on a display device connected to a learning console user device, or the display device of a computer device. In some embodiments, the medium metadata may further comprise the compatibility to a plurality of software platforms and, optionally, runtime environments as determined by the modular learning system 144. In some embodiments, the medium metadata is also used to determine purchase compatibility in the microlearning purchase management module 238 through learning application database 204 and to determine performance compatibility in the microlearning performance management module 240 through learning application database 204.

The Job Skill Metadata 330 is used to receive, store, retrieve, display and update the skills and abilities tagged to the learning application 300 by the learning application authoring user 104, the recruiting user 120 or, optionally, the modular learning system 144 from an exemplary skills and abilities database provided by the modular learning system 144. In some embodiments, the metadata is used by a recruiting user 120 to post the completion of the said learning application (optionally, in a controlled testing environment) or group of applications as a minimum requirement for a particular job role to a plurality of potentially employable learning users. In other embodiments, the metadata is used by the recruiting user 120 to post the requirement of completion of the learning application 300 (optionally, in a controlled testing environment) or group of applications as a minimum requirement for a promotion to a higher post in a particular organization, to a plurality of potentially employable learning users. In some embodiments, the job skill metadata is also used to determine purchase compatibility in the microlearning purchase management module 238 through learning application database 204 and to determine performance compatibility in the microlearning performance management module 240 through learning application database 204.

The Error Metadata 332 is used to receive, store, retrieve, display and update the potential errors which can be made by the learning user 102 (e.g., 10 potential errors in an auditing microlearning application), as determined by the learning application authoring user 104. In some embodiments, wherein the learning application (e.g., a Karnataka History Quiz) is performed through an input device on a user device 140 itself, the error metadata may be synchronized to each potential input point during the learning application 300 performed through the user device 140 by the learning application authoring user 104. In some embodiments, wherein the learning application (e.g., a Karate kata) 300's error metadata is outside the recordable boundaries of the user device 140, the potential errors may be entered with reference to each instructional step of the performance by the learning application authoring user 104, such that at the time of the performance, the tutoring user (or, in some modes, the learning user 102 himself, another learning user, or the recruiting user 120) may note errors in each observable step of the performance and confirm the same on user device 140 to generate the score. In other embodiments, wherein the error observed by the observing user (say, tutoring user 112) is not part of the potential errors in the Error Metadata 332 of the application 300, the tutoring user 112 may update such errors to the Errors Metadata, or optionally, send the same to the learning application authoring user 104, to be updated after review. In some embodiments, the said error metadata is also used to determine purchase compatibility in the microlearning purchase management module 238 through learning application database 204 and to determine performance compatibility in the microlearning performance management module 240 through learning application database 204.

The Template Metadata 334 is used to receive, store, retrieve, display and update the default script, formatting and media components of the learning application template used to author the said learning application 300. In some embodiments, wherein a particular sequence and format of the same has been chosen by the learning content application authoring user from the options offered in the template developed by the learning application template developing user, the chosen setting may be a part of the Template Metadata 334. In various embodiments, the learning application templates may comprise a quiz, role play, simulation, project, experiment, essay, recital, research paper, race, challenge, problem, game, question, exercise or problem set. In some embodiments, the templates may be for performances conducted and supervised in front of a display device with an input device connected to the user device 140, while in other embodiments the said templates may be for previews, reviews and guidelines for performances conducted without the input device, with the user device 140 merely placed next to the performance area or learning station (e.g., for Praxis Tasks in Dance Applications) as a reference point. Although the Template Metadata is described as being composed of various available templates as developed by the learning application template authoring user and chosen by the learning application authoring user, various other templates (e.g., a Swimming Race Template, a Patent Drafting Template) may comprise the Template Metadata 334 and still fall within the scope of various embodiments. In some embodiments, the template metadata is also used to determine purchase compatibility in the microlearning purchase management module 238 through learning application database 204 and to determine performance compatibility in the microlearning performance management module 240 through learning application database 204.

The Tutor Metadata 336 is used to receive, store, retrieve, display and update the compatibility of tutoring users to learning content application. In some embodiments, the tutoring user compatibility is received from and updated by the tutoring user 112 by updating the tutor database 208 (e.g., a Mathematics Tutoring User whose medium of instruction is Mandarin updating compatibility to a plurality of Mathematics microlearning applications available in Mandarin, in the tutor database 208). In other embodiments, the tutoring user compatibility metadata is received from and updated by the tutoring user 112 by accessing the learning application database 204. In still other embodiments, the said tutoring user compatibility metadata may be updated by the modular learning system 144 itself. In some embodiments, the Tutor Metadata is also used to determine purchase compatibility in the microlearning purchase management module 238 through learning application database 204 and to determine performance compatibility in the microlearning performance management module 240 through learning application database 204.

In various embodiments, the metadata of learning application 300 is retrieved, displayed to and updated by a plurality of kinds of users as may be applicable to the kind of metadata and the kind of user. Optionally, in addition to receiving and storing the metadata, the modular learning system 144 may update the learning application metadata as and when generated in the system through a dynamic metadata update module or through a dedicated administering user. In some embodiments, the learning content application authoring user 104 may further play the role of the learning application template developing user. In some embodiments, the modular learning system 144 may play the role of the learning content application authoring user 104 and, optionally, the role of the learning application template developing user 110 to author and update the media and template metadata of the learning application 300.

In some embodiments, the microlearning purchase management module 238 and microlearning performance management module 240 retrieve some or all of the above metadata associated with the learning application 300 from a learning application database 204 in a repository module of the modular learning system 144.

In some embodiments, the media metadata 326 of the learning application may comprise an electronic textbook, an electronic journal, an instructional video, or an instructional animation. In some embodiments each learning application 300, may be a distinct mobile application, browser based web application, or a desktop application. In some embodiments, each learning application 300 may be an executable file, a program, add in, macro, plug-in, or other program of instructions associated with a plurality of application programming interfaces of the modular learning system 144.

Although the learning application 300 is described as comprising various metadata and associated data fields stored and updated in learning application database 204, fewer or more metadata and associated data fields (e.g., Application Programming Interface Metadata, Organization versus Organization Social Learning Mode Metadata, University versus University Social Learning Mode Metadata, Testing Metadata, Learning Visits Metadata, Learning Workshops Metadata, Tutorials Metadata) may comprise the Learning Application 300 and associated learning application database 204, with the present disclosure still falling within the scope of various embodiments. In some embodiments, each version of the same learning application 300 with different metadata, for example language metadata, is treated as a distinct learning application in learning application database 204.

In some embodiments, an authorization to update certification metadata 302 of a learning application 300 is limited to a predetermined plurality of certifying users like user 108 and recruiting users like user 120. In some embodiments, an authorization to update scoring metrics metadata 304, performance type metadata 308, age level metadata 314, authoring metadata 318, mode metadata 324, media metadata 326, medium metadata 328, and error metadata 332 of a learning application 300 is limited to a predetermined plurality of learning application authoring users like user 104. In some embodiments, an authorization to update language metadata 306 of a learning application 300 is limited to a predetermined plurality of learning application translating users 106. In some embodiments, an authorization to update duration metadata 310 of a learning application 300 is limited to a predetermined plurality of learning application authoring users like user 104 and learning application template developing users like user 110. In some embodiments, an authorization to update subject link/tag metadata 312 of a learning application 300 is limited to a predetermined plurality of users in any user role. In various embodiments, such authorizations may be set by an administrator of system 144 based on the user role, user profile information and user preferences information of the corresponding users.

In some embodiments, an authorization to update learning facility metadata 316 of a learning application 300 with associated learning facilities is limited to a predetermined plurality of learning facility administering users like user 124. In some embodiments, an authorization to update sequence metadata 320 of a learning application 300 is limited to a predetermined plurality of learning application authoring users like user 104 and tutoring users like user 112. In some embodiments, an authorization to update tool metadata 322 of a learning application 300 with associated learning tools is limited to a predetermined plurality of tool supplying users like user 118. In some embodiments, an authorization to update job skill metadata 330 of a learning application 300 is limited to a predetermined plurality of recruiting users like user 120. In some embodiments, an authorization to update template metadata 334 of a learning application 300 is limited to a predetermined plurality of learning application authoring users like user 104 and a predetermined plurality of template developing users like user 110. In some embodiments, an authorization to update tutor metadata 336 of a learning application 300 with associated tutoring services is limited to a predetermined plurality of tutoring users like user 112. In some embodiments, an authorization to update an optional learning event metadata of a learning application 300 with associated learning workshops, visits and other learning events is limited to a predetermined plurality of learning workshop organizing users like user 116 and learning visit organizing users like user 114. In some embodiments, the associations of application services to learning applications are enabled automatically by a metadata association module in the system 144. In some embodiments, each learning application 300 is associated with a subset of learning facilities in a learning facilities database 230. In some embodiments, each learning application 300 is further associated with a subset of learning stations of each associated learning facility. In some embodiments, each learning application is associated with a subset of tutoring users in a tutor database 208. In some embodiments, each learning application is associated with a subset of tools in a learning tools database 232.

In an embodiment, the learning application 300 may be associated with a subset of learning facilities in a learning facilities database 230; a subset of learning stations of each associated learning facility; a subset of tutoring users in a tutor database 208, and a subset of tools in a learning tools database 232.

FIG. 3B is a block diagram of a learning application 340 according to another example embodiment. The learning application 340 is illustrated to depict metadata of the learning application related to a plurality of microlearning service stack. The learning application 340 also illustrates some other performance data used during its performance by a learner. This microlearning service stack may be requested for purchase or performance by learning user 102. In this embodiment, the microlearning service stack includes one or more learning applications 340, a time based tutoring service by a particular tutor in database 208, time based access to a particular learning facility from database 230, and access to a particular tool from database 232. The particular services above may or may not be associated with the corresponding tutor metadata, facilities metadata, and tool metadata of learning application 340 at the time of a request. The learning application 340 includes content data 342 which designates particular content media and content attributes of the learning application 340. The learning application also includes other metadata as described above, such as tutor metadata 336, learning facility metadata 316, learning tool metadata 322, performance type metadata 308, and scoring metrics metadata 304. As such, the learning application 340 illustrates some aspects of the learning application used for purchase or performance of the learning application 340 by a learner as part of a microlearning service stack, such as content, tutors, facilities, and tools. The learning application 340 may also include any other metadata as described above with reference to FIG. 3A. Any other metadata as described above with reference to FIG. 3A may also be part of the content data 342 of the learning application 340.

The lifecycle of a learning application 300 is now described according to one embodiment. Initially, a learning application template developing user 110 creates a learning application template stored in a distinct template database in a modular learning system 144. Next, the learning application authoring user 104 publishes learning application content stored as media metadata of the learning application 300. In case a template has been chosen for the application 300, the template metadata is stored as well. The tutor metadata, learning facility metadata, learning tool metadata and other optional application services metadata indicating tutoring services, learning facilities, learning tools, and other application service types associated with the learning application 300 are dynamically updated by the corresponding tutoring users, learning facility administrators, tool suppliers and other application service providers. At this point, the learning user may modularly select application services in a microlearning stack to purchase or perform the learning application. Next, the learning user 102 selects the learning application 300 and identifies application services requested for purchase or performance as a consolidated stack. The approval of the purchase or performance request for learning application 300 and particular application services in the microlearning service stack may be determined by the specific metadata of the learning application 300 being associated with corresponding application services, and other specific metadata of the learning application being compatible with the profile information and preferences of the learning user.

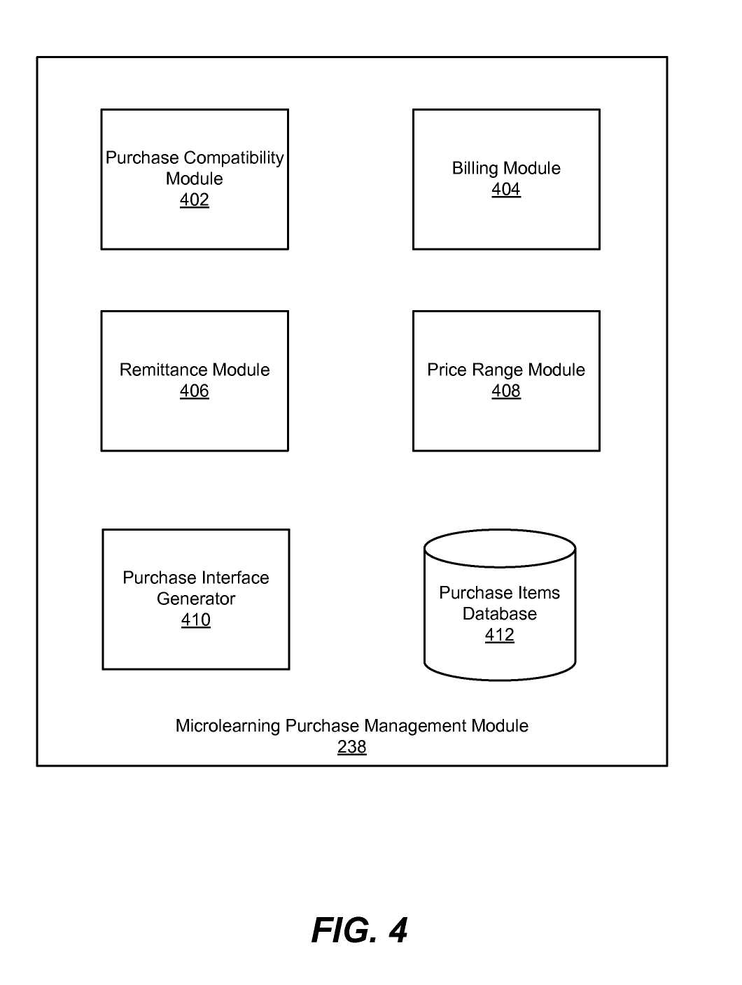

FIG. 4 is a block diagram of the purchase management module 238, according to one embodiment. The purchase management module 238 includes a purchase compatibility module 402, a billing module 404, a remittance module 406, a price range module 408, a purchase interface generator 410 and a purchase items database 412.

The Purchase Compatibility Module 402 is configured for determining the purchase compatibility of the learning application 300 to learning user 102 before granting or denying a purchase request. When the learning application purchase request is compatible with the learning user 102 preferences (e.g., Medium of Instruction preferences) as retrieved from the user database 202 and the learning application 300's metadata fields (e.g., Language Metadata 306) retrieved from the learning application database 204, the learning application 300's purchase request is granted.

The Billing Module 404 is configured for processing the billing to the learning user 102 for the purchase of a microlearning application 300, as well as other purchase items like access to tutoring user 112 for 1 hour during the performance of microlearning application 300, access to learning facility 132 for two hours for performance of learning application 300, purchase of a compatible learning material or tools for the performance of learning application 300, purchase of a learning workshop involving the performance of learning application 300 five times for practice, and other purchase items.

The Remittance Module 406 is configured for remitting the net learning application purchase item amount to the learning content application authoring user 104 and the net application service purchase item amounts to a plurality of microlearning service providers, like tutoring user 112, learning facility administering user 124, learning workshop organizing user 116, learning visit organizing user 114, and learning tool supplying user 118.

The Price Range Module 408 is configured for determining the variable price of a learning application 300, in case the learning application is not sold but accessed for predetermined periods of time by the learning user 102, with prices determined for multiple durations of time by the learning content application authoring user, optionally, within ranges determined by the modular learning system 144. In other embodiments, the price range module 408 is used to set a minimum and maximum quotable price for a plurality of other microlearning services by the modular learning system 144, with the tutoring user 112, learning facility administering user 124, as well as learning workshops and learning visits organizing users 116 and 114 authorized to set the prices for the same within the ranges, respectively. In other embodiments, a plurality of the ranges may be determined by the modular learning system 144 depending on the location of the learning user 102.

The purchase-related metadata of the learning application, like number of copies accessed per day, segmented by location, language, learning facility, user device, as well as other learning related purchase analytics metadata that may be generated during the purchase process may be generated, stored, and updated by the purchase management module 238 in the learning application database 204.

The Purchase Interface Generator 410 is configured for generating a purchase interface on a user device 140 for the learning user 102 to complete the purchase of a learning application and associated application services as a microlearning service stack. The interface provides functionality for the user to search for and purchase learning applications as well as application services.

The Purchase Items Database 412 is configured for storing a plurality of microlearning items which can be purchased by the learning user 102, including a microlearning application 300, as well as other purchase items like access to tutoring user 112 for 1 hour during the performance of microlearning application 300, access to learning facility 132 for two hours for performance of learning application 300, purchase of a compatible learning material or tool for the performance of learning application 300, purchase of a learning workshop involving the performance of learning application 300 five times for practice, and other purchase items. In some embodiments, the purchase items database 412 may store groups of the purchase items as one purchase item in case they are sold as part of a microlearning plan or package. For example, a learning application or group of learning applications may be purchased together with associated application services as a stack.

Although the purchase management module 238 is described as being composed of various modules, fewer or more modules (e.g., a micropayment processor, a tutor services purchase compatibility module, a learning facility purchase compatibility module, a tool purchase compatibility module, a trial performances purchase compatibility module, a learning visits purchase compatibility module, a learning workshops purchase compatibility module, user profile compatibility module) may comprise the module and still fall within the scope of various embodiments.

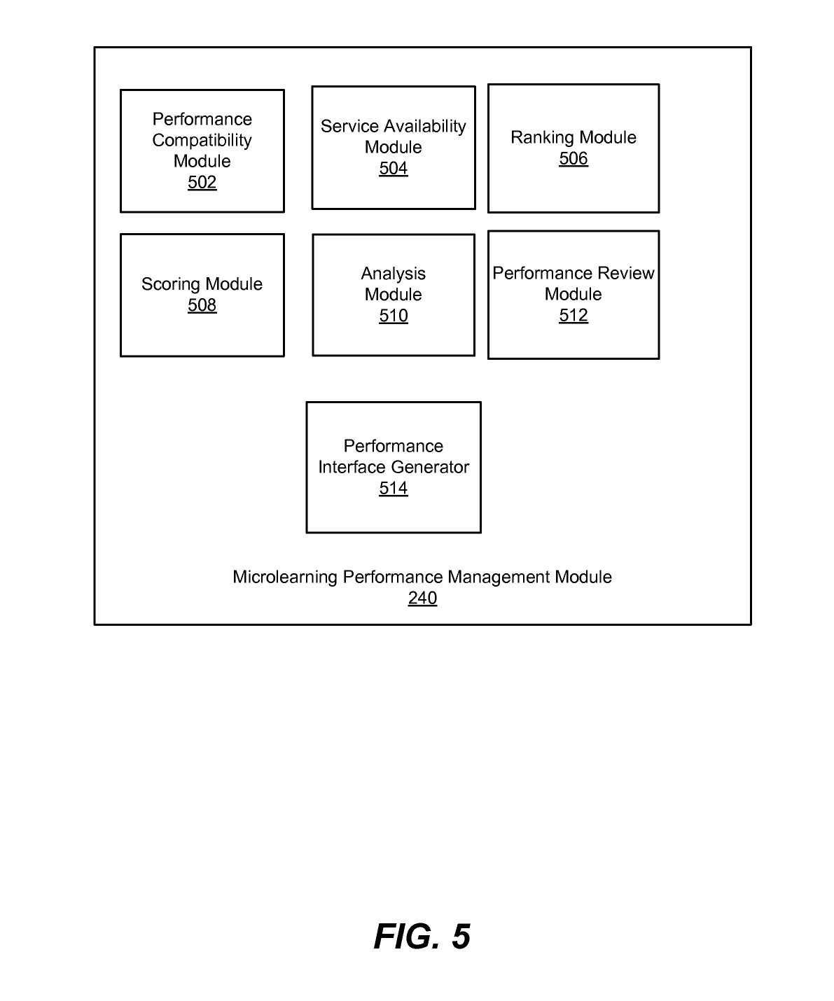

FIG. 5 is a block diagram of a microlearning performance management module 240, according to one embodiment. The performance management module 240 includes various modules for assisting with performance of learning applications and recording performance results of users performing microlearning service stacks like a performance compatibility module 502, service availability module 504, ranking module 506, scoring module 508, analysis module 510, performance review module 512, and performance interface generator 514.

The Performance Compatibility Module 502 is configured for determining requirements for performance of a learning application 300. For example, a chemistry application requiring a wetlab is not compatible with a learning facility 132 that does not have a wetlab. At the time of receiving a performance request for the application, the learning user 102 may be disallowed from beginning the performance of the chemistry learning application 300 at a learning facility 132 since it is not compatible with the learning application that requires a wetlab in its learning facility metadata 316.

The Service Availability Module 504 is configured for determining the immediate availability of a microlearning service stack request by accessing the goods, service or time inventory data fields of a plurality of databases like the tutor database 208, the facilities database 230, a learning visits database and learning tools database 232. In some embodiments, the learning user 102 may have made a particular prior request, say, for a particular tool or tutoring user to be present at a particular learning facility at 12 noon local time on the performance day. In this case, the service availability module 504 may access the plurality of databases to determine the specific availability of the learning user's composite performance request at that particular time before granting the performance request. The specific availability may include, for example, the authenticated check in data of the tutoring user into the requested learning facility at the appropriate time, the authenticated login data of the tutoring user into the user device at the booked learning station or performance area, the confirmation of tool availability at that time and at that learning station or performance area by the learning facility administering user, the availability of the user device, learning station and/or performance area itself.

The Ranking Module 506 is configured for generating a relative rank for the learning user 102 in the specific learning application based on the quantitative, qualitative, manual and, optionally, automated scoring of the performance. The learning user 102's ranking may be based across users of the learning application, or may be based on geographic boundaries, for example ranking the user relative to other learning users within a radius from the user.

The Scoring Module 508 is configured for generating a score for the performance of the learning application in case the learning application can be and has been performed through an input device on the user device 140 itself, based on parameters predetermined in the scoring metrics metadata 304 by the learning content application authoring user 104. In some embodiments, wherein the performance is occurring outside the recordable, measurable, analyzable, scorable and reviewable boundaries of the user device, e.g., Swimming or Skydiving, the scoring component may receive the score manually by the learning user 102 or tutoring user 112 through the user device 140, based on manual scoring parameters predetermined in the Scoring Metrics Metadata 304 by the learning content application authoring user 104.

The Analysis Module 510 is configured for analyzing the performance of the learning application in case the learning application can be and has been performed through an input device on the user device 140 itself.

The Performance Review Module 512 is configured for receiving, storing and updating the qualitative or quantitative review data of a learning application's performance as received from a tutoring user or a learning user via a user device 140 over a network.

The Performance Interface Generator 514 is configured for generating the performance preview and performance review for the learning user 102, and, optionally, the tutoring user present with the learning user. In some embodiments, wherein the learning performance can be completed through user device 140 through a input device attached to the user device 140 like a keyboard, mouse, or learning peripheral, the performance interface generator displays the performance interface on a screen on the user device 140. In various embodiments, the media metadata and the template metadata associated with the learning application are generated on the learning user device screen by the performance interface generator 514 during the performance preview, performance review, and, optionally, during the performance. In various embodiments, such a performance interface is generated at learning facility 132 through a user device 140 when the learning application's learning facility metadata 316 requires it to be performed at such a learning facility.

Although the microlearning performance management module 240 is described as being composed of various modules, fewer or more modules (e.g., a job skill compatibility component, a performance recording component, a performance measuring device bus, a tutor services performance compatibility module, a learning facility performance compatibility module, a tool performance compatibility module, a trial performances compatibility module, a learning visits performance compatibility module, a learning workshops performance compatibility module, user profile compatibility module) may comprise the module and still fall within the scope of various embodiments.

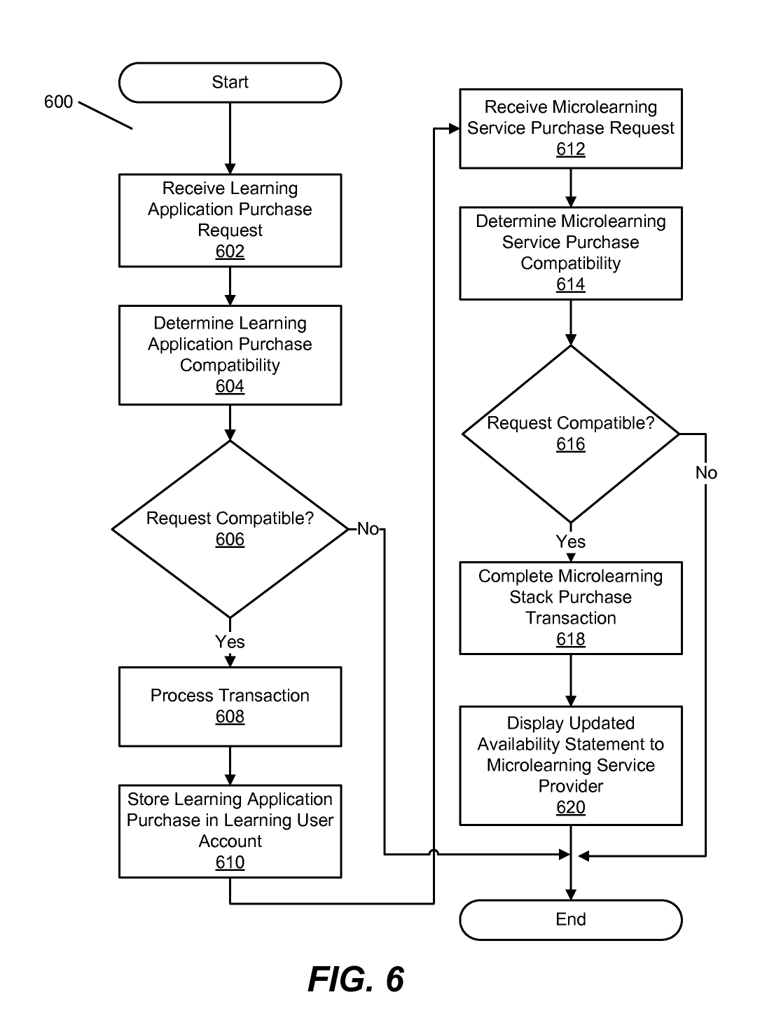

FIG. 6 is a flow diagram 600 of a method for a learning user to purchase a microlearning service stack, according to one embodiment. This method is enabled by purchase management module 238. At step 602, the modular learning system 144 receives a microlearning application 300 purchase request from learning user 102 user device 140. In some embodiments, the learning application may be made available for free by the learning content application authoring user 104. In other embodiments, the learning application may be purchased in advance stored on the learning user's account for future access during a learning performance. In other embodiments, the learning application 300 may be purchased by the learning user 102 immediately before the microlearning stack purchase request.

At step 604, the modular learning system 144 requests the purchase compatibility module 402 to determine the compatibility of the learning application 300 to the learning user 102, before allowing the purchase request. As described above, the purchase compatibility module 402 determines whether the learning user matches compatibility information for the learning application. For example, an advanced microbiology learning application 300 available only in Japanese and for a suggested age of 15 years+may not be compatible for purchase by a learning user 102 of age 10 whose listed medium of instruction is Spanish.

At step 606, the purchase compatibility module 402 determines the purchase compatibility of the learning application 300 and the purchase request is granted or denied. In case the learning application purchase request is incompatible with the learning user 102 preferences as retrieved from the user database 202 and the plurality of learning application 300's metadata fields retrieved from the learning application database 204, the learning application 300 purchase request is denied.

At step 608, when the purchase request is compatible with the user profile information and user preferences information associated with the learning user 102, the modular learning system 144 processes the transaction based on the price in the purchase items database 412, and remits the net amount to the learning application authoring user 104 via remittance module 406. The billing module 404 displays the transaction in the learning user's account summary and the purchase items database 412 records the sale of one unit of the learning application purchase item. In some embodiments, wherein the learning application 300 is not sold but the learning user 102 is granted temporary access to the learning application for a limited time, the price range module 408 is used to determine the price depending on the time for access of the learning application 300 as chosen by the learning user 102.

At step 610, the learning application 300 is stored for future performance access in the learning user 102 account, and the user database 202 is updated with a confirmation of the same. In some embodiments, a plurality of other users in user database 202 are associated with the learning application 300, like a translating user, a learning application template developing user, and a learning application certifying user. These users may also be updated with a confirmation the purchase transaction.

The user identifies which distinct application services the user prefers to use with the learning application, and at step 612, the modular learning system 144 receives a microlearning service purchase request from learning user 102 via purchase interface on a user device 140. The application service purchase request may be for a tutoring service, learning facility access, tool access, workshop access, or learning visit access associated with the specific learning application 300 or a group of such learning applications. That is, the user identifies which facility, tutor, tools, and other microlearning services the user wishes to use to learn with the learning application.

At step 614, the microlearning purchase management module 238 requests the purchase compatibility module 402 to determine the compatibility of the microlearning service purchase request to the learning application 300 for which the purchase request is made. For example, an advanced microbiology learning application 300 purchased by a learning user of age 16 whose listed medium of instruction is Japanese may not be compatible with a tutoring service offered by a microbiology tutoring user in Japan whose listed medium of instruction is English. In case the learning application 300 is a microbiology experiment and requires a wet lab, and the learning user 102 has requested learning facility access for one hour for the same for the experiment performance, such a request may not be compatible with a learning facility 132 that does not offer a wet lab.

At step 616, the purchase compatibility module 402 determines the purchase compatibility of the learning application 300 with the microlearning service request before denying or granting the purchase request, including learning facility access purchase request compatibility through learning facility metadata 316, tutor access purchase request compatibility through tutor metadata 336 as well as tool access purchase request compatibility through tool metadata 322. In case the learning facility, tutor tool access request or other purchase request is incompatible with the learning application 300 (or, optionally, unavailable for the learning application 300), the microlearning service purchase request is denied. In some embodiments, the learning facility database 230, learning tools database 232, tutor database 208 and learning application database 204 are accessed by the purchase compatibility module 402, to determine purchase compatibility based on data fields, preferences and learning application metadata associated with these application services. In other embodiments, in addition to the learning application metadata (e.g., language metadata received by the learning application authoring user 104 and the translating user 106) the user database 202 may be accessed by the purchase compatibility module 402 to determine purchase compatibility based on data fields and preferences (e.g., language preferences) entered by the learning user 102. In case the purchase compatibility module 402 determines that the specific microlearning stack purchase request is not compatible, the request is denied.

At step 618, the purchase management module 238 processes the transaction and remits the net amount to the application services provider through remittance module 406. The billing module 404 displays the transaction in the learning user's account summary. At step 620, the remittance module 406 displays the updated availability statement to the application service provider. In some embodiments, the availability statement is generated by the service availability module 504 in the microlearning performance management module 240.

In some embodiments, determining learning application compatibility to the purchase request at step 606 further comprises the steps of retrieving user profile information and user preferences information associated with the learning user from a learning user database, retrieving metadata associated with the learning application from the learning application database, determining whether the learning application's metadata is compatible with corresponding learning user information through a purchase compatibility module in a purchase management module, if so, proceeding to process the purchase transaction, and if not, denying the purchase request and optionally displaying an error interface item on the user device associated with the learning user indicating that the purchase request is incompatible.

In some embodiments, determining learning application compatibility to a requested application service at step 616 further comprises retrieving user profile information and user preferences information associated with the learning user from a learning user database, retrieving application service data fields and associated user profile information from a plurality of corresponding user databases of application service providers or optionally, a dedicated application services database, retrieving metadata associated with the learning application from the learning application database, determining whether the application service is associated with the learning application purchased, through a purchase compatibility module in a purchase management module, if so, proceeding to process the purchase transaction, and if not, denying the purchase request and optionally displaying an error interface item on the user device associated with the learning user indicating that the purchase request is incompatible.

In some embodiments, determining application service compatibility to purchase request at step 616 further comprises the step of determining whether an application service's attributes are compatible with corresponding learning user information through the purchase compatibility module in the purchase management module before proceeding to process the purchase transaction. In some embodiments, the attribute of the application service is an address or geographic location of service availability, and learning user profile information or user preference information is the address or geographic location of performance.

In some embodiments, the determination at step 616 is processed sequentially or simultaneously for a plurality of application services in the stack requested for purchase. In some embodiments, an application service purchase request comprises a time based tutoring service associated with a tutoring user and tutor metadata of the learning application, a time based learning facility access service associated with a learning facility and learning facility metadata of the learning application; and a learning tool access service associated with a learning tool and learning tool metadata of the learning application.

In some embodiments, the determination at step 616 is processed for a plurality of application services in the same stack requested for purchase. In some embodiments, the purchase request comprises at least one tutor access purchase request, learning facility access purchase request, tool access purchase request, tool purchase request, and trial performance purchase request associated with the learning application. In some embodiments, the learning application purchase request comprises more than one learning application. In some embodiments, the application service purchase request comprises more than one application service. In some embodiments, the purchase request comprises a time based tutoring service associated with a tutoring user and tutor metadata of said learning application, a time based learning facility access service associated with a learning facility and learning facility metadata of said learning application; and a learning tool access service associated with a learning tool and learning tool metadata of said learning application.

In some embodiments, the purchase request of learning application 300 is denied in case the language metadata 306 is incompatible with the medium of instruction or language of the learning user as indicated in the user's profile or preferences information.

In some embodiments, the purchase request of learning application 300 is denied in case the age level metadata 314 is incompatible with the age of the learning user as indicated in the user's profile or preferences information.

In some embodiments, the purchase request is denied in case the user device associated with the learning user and used to request the purchase is incompatible with the medium metadata 328 of the requested learning application.

In various embodiments, the purchase request of learning application 300 is denied in case the any other metadata is incompatible with the corresponding user profile or preferences information of the learning user.

In some embodiments, the application service purchase request in a microlearning stack is denied in case learning facility access is requested at a learning facility not associated with the learning facility metadata 316 of the learning application 300.

In some embodiments, the application service purchase request in a microlearning stack is denied in case tutoring user access is requested for a tutoring user not associated with the tutor metadata 336 of the learning application 300.

In some embodiments, the application service purchase request in a microlearning stack is denied in case tool access is requested for a tool not associated with the tool metadata 322 of the learning application 300.

In various embodiments, the purchase request of application services in a microlearning stack is denied in case any other application service access is requested for an application service not associated with its corresponding metadata of the learning application 300.

In some embodiments, the purchase request of application services in a microlearning stack is denied in case the medium of instruction of the tutoring service or tutoring user is incompatible with the medium of instruction or language of the learning user as indicated in the user's profile or preferences information.

In other embodiments, the purchase request of application services in a microlearning stack is denied in case the location of the tutoring service or tutoring user is incompatible with the location of the learning user as indicated in the user's profile or preferences information.

In other embodiments, the purchase request of application services in a microlearning stack is denied in case the location of the learning facility is incompatible with the location of the learning user as indicated in the user's profile or preferences information.

In other embodiments, the purchase request of application services in a microlearning stack is denied in case the location of the learning tool is incompatible with the location of the learning user as indicated in the user's profile or preferences information.

In various embodiments, the purchase request of application services in a microlearning stack is denied in case an attribute of the application service or a user associated with the application service is incompatible with the corresponding user profile or preferences information of the learning user.

Although the method for a learning user to purchase a microlearning service stack is described as being composed of various steps (e.g., Receiving Learning Application Purchase Request from Learning User, Display Updated Availability Statement to Microlearning Service Provider), fewer or more steps (e.g., Determine Learning Application Compatibility to Purchase Request within a Particular Country, Determine Learning Application Compatibility to Purchase Request within a particular Microlearning Plan, Determine Availability of requested Microlearning Service compatible with Learning Application, and Determine Availability of requested Tutoring Services for Learning Application) may comprise the method and still fall within the scope of various embodiments.

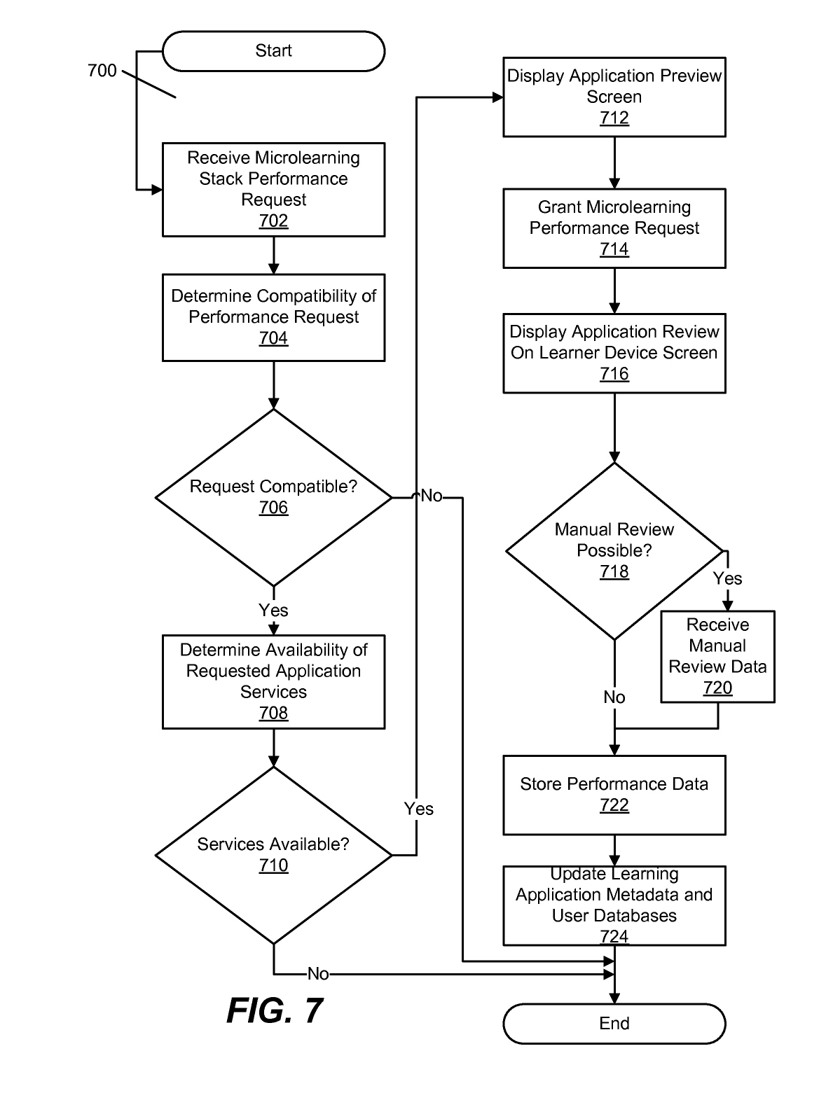

FIG. 7 is a flow diagram 700 of a method for a learning user to perform a microlearning service stack based on a learning application 300, according to one embodiment. At step 702, the modular learning system 144 receives a microlearning stack performance request from learning user 102 via user device 140. In some embodiments, such a request may be placed in advance by the learning user 102 to request access to a learning facility 132 or to request access to tutoring user 112. A microlearning service performance or a microlearning stack performance may a learning application and associated application services.

At step 704, the modular learning system 144 requests the compatibility module 502 to determine the compatibility of the microlearning stack performance request to the microlearning application for which the performance request is made through performance compatibility module 502. For example, if a tutoring user of Indian classical dance is not compatible with the microlearning application of breaststroke purchased earlier by the learning user 102, the performance request is denied.

At step 706, the compatibility module 502 determines the performance compatibility of the learning application 300 with the metadata of all application services required to be available during the learning application's performance before denying or granting the performance request, including learning facility request compatibility through learning facility metadata 316, tutor request compatibility through tutor metadata 336 as well as tool compatibility through learning tools metadata 322. In case the learning facility, tutor, tool or other application service request is incompatible with the learning application 300 (or, optionally, unavailable but required during the performance according to the learning application 300 metadata), the microlearning stack's performance request is denied. In some embodiments, the learning facility database 230, learning tools database 232, tutor database 208 and learning application database 204 are accessed by the performance compatibility module 502, to determine compatibility based on data fields, preferences and learning application metadata received or generated therein by learning facility administering user 124, learning tools supplying user 118 and tutoring user 112. In other embodiments, in addition to the learning application 300 metadata, (e.g., Language Metadata 306 received by the learning application authoring user 104, and, in this case, optionally, the translating user 106) the user database 202 may be accessed by the performance compatibility module 502 to determine performance compatibility based on data fields and preferences (e.g., Language preferences) entered by the learning user 102. In case the performance compatibility module 502 determines that the specific microlearning stack performance request is not compatible, the request is denied.

At step 708, wherein the compatibility module 502 determines that the microlearning stack performance request is compatible, a request is sent to the service availability module 504 to determine the immediate availability of the performance request.

At step 710, the service availability module 504 determines the immediate availability of the microlearning request by accessing the goods, service or time inventory data fields of a plurality of databases of the applicable services. In some embodiments, the learning user 102 may have made a particular prior request for a particular tool or tutoring user to be present at a particular learning facility in advance on the performance day. In such a case, the service availability module 504 may access the plurality of databases to determine the specific availability of the learning user's composite performance request at that particular time (e.g., the authenticated check in data of the tutoring user into the requested learning facility at the appropriate time, the authenticated login data of the tutoring user into the user device at the booked learning station or performance area, the confirmation of tool availability at that time and at that learning station or performance area by the learning facility administering user, the availability of the user device, learning station and/or performance area itself), and only upon receiving the same, displays the microlearning application preview screen to the learning user 102.

At step 712, the performance interface generator 514 displays the preview of the microlearning application 300. In some embodiments wherein the performance (e.g., Dance, Karate kata) will occur outside the recordable, measurable, analyzable, scorable and reviewable boundaries of the user device, (e.g., Swimming, Skydiving) the performance interface generator 514 may display a set of instructional steps for the learning user to observe during the performance.

At step 714, the performance management module 240 grants the microlearning performance request with compatible application services and the performance interface generator 514 displays the media metadata predetermined by the learning content application authoring user 104 based on duration metadata and mode metadata. In some embodiments wherein the performance is occurring outside the recordable, measurable, analyzable, scorable and reviewable boundaries of the user device, (e.g., Swimming, Skydiving, Dance or Karate kata) the performance interface generator 514 may display a set of instructional steps for the learning user to observe during the performance. Optionally, time cues may be attached to each such step with an audiovisual cue indicating the beginning or end of the next or previous instructional step. In some embodiments, especially doing (praxis) and making (poeisis) performances, wherein the instructional media has been viewed by the learning user on the preview screen during step 712, the performance interface generator 514 may display any of the learning application metadata like scoring metrics metadata 304 generated live (or, optionally, received live from the tutoring user 112) during the learning performance, or error metadata 332 generated live (or, optionally, received live from the tutoring user 112) based on a request for the same from the learning user 102, or, optionally, predetermined into the learning application by the learning application authoring user 104. In other embodiments, especially in case of praxis or poeisis performances not performed or requiring user device 140, the performance interface generator may display a blank screen until the completion of the performance at a predetermined time based on duration metadata as determined by the learning application authoring user 104, or optionally, determined by the learning user 102 or tutoring user 112.

At step 716, the performance interface generator 514 displays the performance review and summary of the microlearning service performance on the screen of user device 140. In some embodiments, wherein the learning application is performed on the user device 140 itself, the analysis module 510, scoring module 508 and ranking module 506 generate an analysis, score and rank for the learning performance and display the same on the performance review screen on user device 140.

At step 718, in some embodiments wherein the performance has occurred outside the recordable, measurable, analyzable, scorable and reviewable boundaries of the user device, (e.g., Swimming, Skydiving) the performance interface generator 514 displays a manual review screen on to be filled in with quantitative and/or qualitative scores, and reviews by the learning user 102 and/or the tutoring user 112 via a user device 140. In some embodiments, (e.g., Dance, Theatre) the user device 140, may be placed next to the learning infrastructure, learning station or performance area at the learning facility 132.

At step 720, the manual scoring and/or review data is received through the user device 140 from the learning user 102 and, optionally, the tutoring user 112.

At step 722, the performance review data is stored in the performance review module 512 of the performance management module 240. In some embodiments, wherein the learning application's medium metadata 328 indicates a learning application 300 can be performed over the same user device 140 used to access the modular learning system 144 over a network, the performance review data can be received from a tutoring user 112 accessing the learning user's performance data on a separate user device 140 by accessing the modular learning system 144 over a network.

At step 724, the metadata of learning application 300 as well as the learning application database 204 is updated with the performance and/or performance review data generated (and, optionally, received) during (and optionally, after) the microlearning stack's performance. In some embodiments, the learning user's database is updated with performance and/or performance review data generated (and, optionally, received) during (and optionally, after) the microlearning stack's performance. In other embodiments, the tutoring user's database is updated with the learning user's said performance data and/or said performance review data (with the learning user's explicit consent). In some embodiments, wherein the learning application metadata allows for a plurality of learning users to perform the microlearning stack's performance simultaneously or sequentially as part of the same application performance, the plurality of databases of users involved in the microlearning stack's performance are updated with the performance and/or performance review data received or generated by the performance management module 240.

In some embodiments, determining compatibility of the performance request at step 706 further comprises the steps of retrieving user profile information and user preferences information associated with the learning user from a learning user database, retrieving metadata associated with the learning application from the learning application database, determining whether a requested application service is associated with a requested learning application through a performance compatibility module in a performance management module, if so, proceeding to determine service availability of requested application services, and if not, denying the performance request and optionally displaying an error interface item on the user device associated with the learning user indicating that the performance request is incompatible.

In some embodiments, in case where the learning application or application services are provided independent of purchase transaction, determining compatibility of the performance request at step 706 further comprises the step of determining whether the learning application's metadata is compatible with corresponding learning user information through the performance compatibility module in the performance management module.

In some embodiments, determining whether the learning application's metadata is compatible with corresponding learning user information at step 706 further comprises the step of determining the service availability of application services designated as required for the performance by an authoring user associated with the learning application.

In some embodiments, determining availability of requested application services at step 710 further comprises the steps of retrieving a set of application service data fields, time inventory or unit inventory data fields and associated user profile information from a plurality of corresponding user databases or a dedicated application services database, determining composite availability of all application services in a requested microlearning stack, if services are available, proceeding to process the performance request for the requested microlearning stack, and if not, denying performance request and optionally displaying an error interface item on the user device associated with the learning user indicating that all the application services in the requested microlearning stack are unavailable.

In some embodiments, determining composite availability of all application services in the requested microlearning stack at step 710 further comprises the steps of accessing an authenticated check in data of a tutoring user checking in at a requested learning facility at a predetermined time, accessing authenticated login data of the tutoring user received via user device at the requested learning facility, accessing tool availability confirmation data at the predetermined time and duration at a learning facility as entered in via a user device by a learning facility administering user, accessing tool availability confirmation data of a predetermined user device, learning station or performance area of the requested learning facility, at the predetermined time for a predetermined duration. In some embodiments, service availability is determined at a predetermined time prior to a scheduled performance time of the requested microlearning stack. In some embodiments, service availability is determined automatically at a scheduled performance time of the requested microlearning stack. In some embodiments, the performance request comprises more than one learning application. In some embodiments, the performance request comprises more than one application service. In some embodiments, the performance request comprises a time based tutoring service associated with a tutoring user and tutor metadata of the learning application, a time based learning facility access service associated with a learning facility and learning facility metadata of the learning application, and a tool access service associated with a tool supplying user and tool metadata of the learning application.

In some embodiments, determining availability of requested application services at step 710 further comprises the step of denying the performance request in case an application service is not available. In some embodiments, determining composite availability of all application services in the requested microlearning stack at step 710 further comprises the step of receiving service availability confirmation via a user device associated with a compatible learning facility by the learning user or a learning facility administering user.

In some embodiments, determining composite availability of all application services in the requested microlearning stack at step 710 further comprises steps of receiving service availability confirmation via a user device associated with the learning user. In some embodiments, determining composite availability of all application services in the requested microlearning stack comprises receiving service availability confirmation via a user device associated with a tutoring user, tool supplying user, workshop organizing user, or a microlearning event organizing user whose application service is requested within a microlearning service performance request.

In some embodiments, determining compatibility of the performance request at step 706 further comprises the steps of denying the performance request in case the performance request is incompatible with any of mode metadata or performance type metadata of the learning application, and learning user profile information or preferences information. In some embodiments, determining compatibility of the performance request at step 706 further comprises denying the performance request in case at least one learning application or at least one application service associated with a requested application services stack is not purchased prior to receiving the performance request. In some embodiments, the performance request comprises at least one predetermined unit of a tutoring user's time, predetermined unit of access time to a learning facility, predetermined unit of access time to a learning tool, predetermined unit of a learning tool, and predetermined unit of a trial performance associated with the learning application.

In some embodiments, the application service is a predetermined unit of a tutoring user's time associated to a limited plurality of learning applications. In some embodiments, the application service is a predetermined unit of access time to a learning facility associated to a limited plurality of learning applications. In some embodiments, the application service is a predetermined unit of access time to a learning tool associated to a limited plurality of learning applications. In some embodiments, wherein the application service is a predetermined unit of a learning tool associated to a limited plurality of learning applications. In some embodiments, the application service is a predetermined unit of access time to a learning event associated to a limited plurality of learning applications.

In some embodiments, a learning event comprises a plurality of microlearning service stacks, each stack comprising at least one learning application and at least one associated application service. In some embodiments, the application service is a predetermined unit of a trial performance associated to a limited plurality of learning applications. In some embodiments, the learning event comprises a learning visit, or a learning workshop. In some embodiments, the application services are associated to the limited plurality of learning applications by authorized users in any user role. In some embodiments, the learning facility may further comprise an independent learning facility, an institutional learning facility, a workspace learning facility, a temporary learning facility. In some embodiments, the learning facility may optionally comprise a tutor managed learning facility associated with a tutoring user. In some embodiments, the learning facility further comprises a plurality of learning stations associated with a limited plurality of learning applications.

In some embodiments, the service availability at step 710 is determined at a user device associated with a compatible learning facility by the learning user or a learning facility administering user. In some embodiments, the service availability at step 710 is determined at a user device associated with the learning user. In some embodiments, the service availability at step 710 is optionally determined at a user device associated with a tutoring user, tool supplying user, workshop organizing user, or a microlearning event organizing user whose application service is requested within a microlearning service performance request.

In some embodiments, the method of invention includes displaying application preview screen on the user device associated with the learning user in case requested application service is available. Further, displaying application performance screen on the user device associated with the learning user. Followed by displaying application review screen on the user device associated with the learning user. The method, according to this embodiment, further includes determining whether a manual review of a performance can be conducted via the user device by the learning user or a user authorized by the learning user. Followed by receiving manual review data when the performance is reviewed via the user device by the learning user or the user authorized by the learning user. Finally, storing performance review data in a microlearning performance management module 240.

In some embodiments, the application service involves time based remote virtual access to an associated tutoring user over a video conferencing system, a remote access environment, an audio conferencing system, a social networking environment, a professional networking environment, a telecommunications network, or a general purpose web based or mobile based audio visual communications application accessed by a tutoring user and the learning user via respective user devices over a network. In an embodiment application service may comprise a predetermined unit of a tutoring user's time associated to limited plurality of learning applications, a predetermined unit of access time to a learning facility associated to the limited plurality of learning applications, a predetermined unit of access time to a learning tool associated to the limited plurality of learning applications, a predetermined unit of the learning tool associated to limited plurality of the learning applications, a predetermined unit of access time to a learning event associated to the limited plurality of learning applications, and a predetermined unit of a trial performance associated to the limited plurality of learning applications.

In some embodiments, the performance request of the microlearning stack is denied in case the language metadata 306 of the learning application 300 is incompatible with the medium of instruction or language of the learning user as indicated in the user's profile or preferences information.

In some embodiments, performance request of the microlearning stack is denied in case the age level metadata 314 of the learning application 300 is incompatible with the age of the learning user as indicated in the user's profile or preferences information.

In some embodiments, performance request of the microlearning stack is denied in case the user device associated with the learning user and used to request the purchase is incompatible with the medium metadata 328 of the requested learning application 300.

In various embodiments, performance request of the microlearning stack is denied in case the any other metadata of the learning application 300 is incompatible with the corresponding user profile or preferences information of the learning user.

In some embodiments, performance request of the microlearning stack is denied in case learning facility access is requested at a learning facility not associated with the learning facility metadata 316 of the learning application 300.

In some embodiments, performance request of the microlearning stack is denied in case tutoring user access is requested for a tutoring user not associated with the tutor metadata 336 of the learning application 300.

In some embodiments, performance request of the microlearning stack is denied in case tool access is requested for a tool not associated with the tool metadata 322 of the learning application 300.

In various embodiments, performance request of the microlearning stack is denied in case any other application service access is requested for an application service not associated with its corresponding metadata of the learning application 300.

In some embodiments, the performance request of the microlearning stack is denied in case the medium of instruction of the tutoring service or tutoring user is incompatible with the medium of instruction or language of the learning user as indicated in the user's profile or preferences information.

In other embodiments, the performance request of the microlearning stack is denied in case the location of the tutoring service or tutoring user is incompatible with the location of the learning user as indicated in the user's profile or preferences information.

In other embodiments, the performance request of the microlearning stack is denied in case the location of the learning facility is incompatible with the location of the learning user as indicated in the user's profile or preferences information.

In other embodiments, the performance request of the microlearning stack is denied in case the location of the learning tool is incompatible with the location of the learning user as indicated in the user's profile or preferences information.

In various embodiments, the performance request of the microlearning stack is denied in case an attribute of the application service or a user associated with the application service is incompatible with the corresponding user profile or preferences information of the learning user.

In some embodiments, the performance request of the microlearning stack is denied in case the user device or plurality of user devices required to perform the learning application in a multi user mode are incompatible with the mode metadata 324 of the requested learning application.

In some embodiments, the performance request of the microlearning stack is denied in case learning facility access is requested at a user device at a learning facility not present in the learning facility metadata 316 of the requested learning application.

In some embodiments, the performance request of the microlearning stack is denied in case tutor access is requested at a user device for a tutoring user not present in the tutor metadata 336 of the requested learning application.

In some embodiments, the performance request of the microlearning stack is denied in case tool access is requested at a user device for a tool not present in the tool metadata 322 of the requested learning application.

In various embodiments, the performance request of the microlearning stack is denied in case a compatible application service is unavailable at the time requested for performance.

In some embodiments, (e.g., a learning user on a postpaid learning plan), the method 700 may be executed before the method 600. In other embodiments, the steps of method 600 and method 700 may be edited and combined to form a single method for certain microlearning stack purchases and performances without deviating from the spirit of the disclosure. In some embodiments the microlearning stack purchased using the method 600 is identical to the microlearning stack performed using the method 700. In other embodiments, learning applications and application services purchased in two or more stacks using method 600 are rearranged to form at least one distinct microlearning service stack requested to be performed using the method 700. Although the method for a learning user to perform a microlearning service stack is described as being composed of various steps, fewer or more steps (e.g., Determine Learning Application Compatibility to Performance Request within a Particular Learning Facility, Determine Learning Application Compatibility to Performance Request with a particular Tool, Determine Availability of requested Workshops compatible with said Learning Application, and Determine Availability of requested Tutoring Services for said Learning Application) may comprise the method and still fall within the scope of various embodiments.

### Computing Machine Architecture

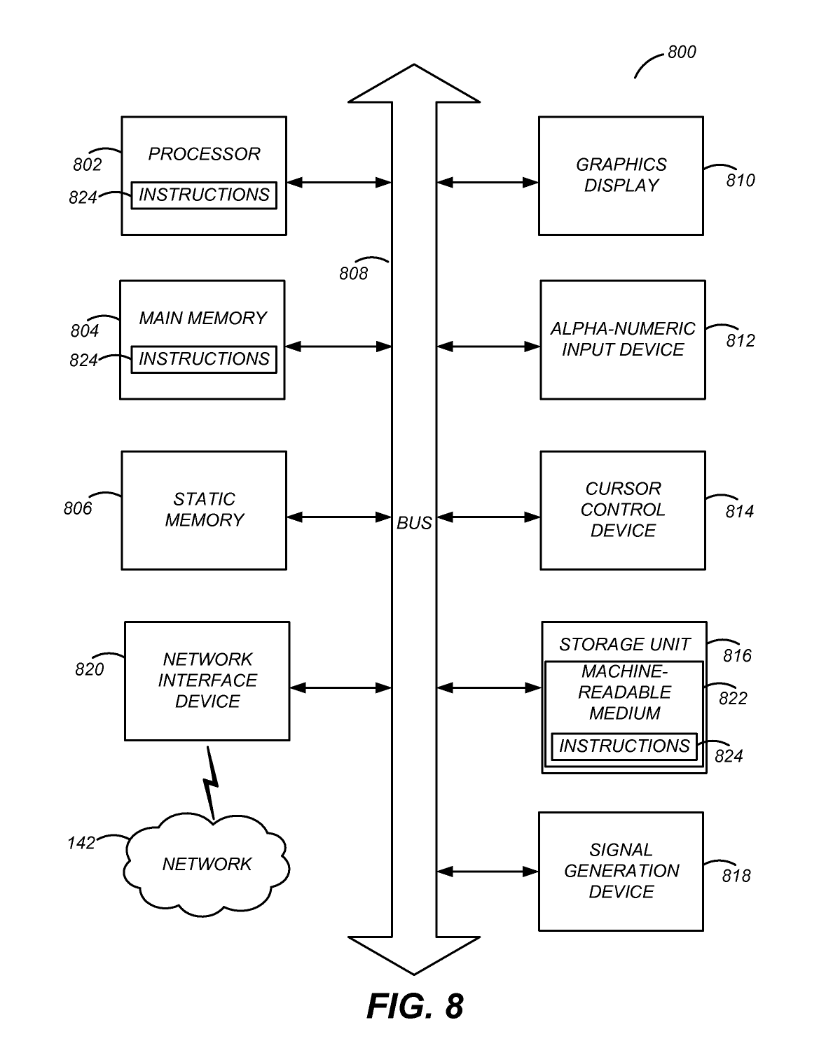

FIG. 8 is a block diagram illustrating components of an example machine suitable for use as a modular learning system 144, in which any of the embodiments disclosed herein may be performed, according to one embodiment. This example machine is able to read instructions from a machine-readable medium and execute them in a processor (or controller).

Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 142 via the network interface device 820.

While machine readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

The modular learning system 144 may be one or more servers in which one or more methods disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of the modular learning system 144. The static memory 806 may be a hard drive, a flash drive, and/or other memory information associated with the modular learning system 144.

The bus 808 may be an interconnection between various circuits and/or structures of the modular learning system 144. The video display 810 may provide graphical representation of information on the modular learning system 144. The alphanumeric input device 812 may be a keypad, keyboard and/or any other input device. The cursor control device 814 may be a pointing device such as a mouse.

The storage unit 816 may be a hard drive, a storage system, and/or other longer term storage subsystem. The signal generation device 818 may be a bios and/or a functional operating system of the modular learning system 144. The network interface device 820 may be a device that may perform interface functions such as code conversion, protocol conversion and/or buffering required for communication to and from a network (e.g., the network 142 of FIG. 1). The machine readable medium 822 may provide instructions 824 on which any of the methods disclosed herein may be performed. The instructions 824 may provide source code and/or data code to the processor 802 to enable any one/or more operations disclosed herein. For example, the modular learning system 144 may be stored in the form of instructions 824 on a storage medium such as the main memory 804 and/or the machine readable medium 822 such as compact disk.

In one embodiment, a non-transitory computer-readable storage medium having a program executable by a computing device (e.g., the modular learning system 144) causes the computing device to perform method steps illustrated in FIG. 6 and FIG. 7.

According to one embodiment, the modular learning system 144 of FIG. 1 comprises the purchase management module 238, performance management module 240 and other modules deployed in one or more servers (e.g., application servers) and the user databases, application service databases for each distinct application service type and other databases of FIG. 2, stored within a repository which is further deployed in a database server. In such an embodiment, the application server and database server are accessed by each user through user device 140 via network 142.

According to another embodiment, the modular learning system 144 of FIG. 1 comprises the purchase management module 238, performance management module 240, and other modules; a repository including the user databases, application service databases and other databases of FIG. 2, wherein the modules and repository are deployed in an exemplary cloud architecture so that the microlearning services are provided as a cloud service.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including functionality implemented in computing logic or a number of components, modules, or mechanisms, for example, as illustrated in FIGS. 2, 4, and 5. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

In another embodiment, the microlearning purchase and performance interface provided by the modular learning system 144 can be accessed over a local area network, intranet or virtual private network accessible to a limited plurality of user devices at a preschool, school, college, university, educational board, professional standards authority, coaching class, a company, HR department, training department or at a training organization through a user device.

In another embodiment, the microlearning purchase and performance interface provided by the modular learning system 144 can be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

According to the embodiments described in FIG. 1 through 7, various methods and electric structures may be embodied using transistors, logic gates, and electrical circuits (e.g., Application Specific Integrated Circuitry and/or in Digital Signal Processor circuitry). For example, the purchase management module 238, performance management module 240 and other modules of FIGS. 1 to 7 may be enabled using a purchase management circuit, a performance management circuit, and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a process for managing the purchase and performance of learning applications and associated application services in a microlearning stack through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1-119. (canceled)

120. A computer implemented method for purchasing a microlearning service comprising at least one learning application and at least one associated application services stack, the method comprising:
maintaining a plurality of user databases, each user database associated with a distinct user role and comprising user profile information and preferences for a plurality of users;
maintaining a learning application database comprising a plurality of learning applications, wherein, a learning application comprising a learning application metadata and an application services metadata;
maintaining a plurality of application services databases, each application services database associated with application service types and comprising learning services;
receiving a learning application purchase request from a user device associated with a learning user via a network, wherein the learning user is associated with a user profile in one of the plurality of user databases, and the learning application purchase request indicates a requested learning application of the plurality of learning applications;
determining a compatibility of the requested learning application to the learning application purchase request;
processing a purchase transaction for the learning application purchase request;
storing the learning application in an account associated with the learning user;
receiving a service purchase request for an application service from the user device associated with the learning user;
determining the compatibility of the learning application to requested application service; and
processing the purchase transaction for the service purchase request.

121. The computer implemented method of claim 120, wherein determining the compatibility of the purchase request further comprises:
retrieving user profile information and user preferences information associated with the learning user from a learning user database;
retrieving metadata associated with the learning application from the learning application database;
comparing the metadata of the learning application with corresponding learning user information through a purchase compatibility module in a purchase management module to determine the compatibility; and
denying the purchase request transaction by displaying an error interface item on the user device associated with the learning user in case the purchase request is incompatible.

122. The computer implemented method of claim 120, wherein determining the compatibility of the requested application service further comprises:
retrieving user profile information and user preferences information associated with the learning user from a learning user database;
retrieving application service attributes and associated user profile information from a plurality of corresponding user databases of application service providers or optionally, a dedicated application services database;
retrieving metadata associated with the learning application from the learning application database;
comparing the metadata of the application service is associated with the learning application purchased with corresponding learning user information through a purchase compatibility module in a purchase management module to determine the compatibility; and
denying the purchase request transaction by displaying an error interface item on the user device associated with the learning user in case the purchase request is incompatible.

123. The computer implemented method of claim 122, wherein the application service's attributes are an address or geographic location of service availability, and the corresponding learning user profile information and/or user preference is the address or geographic location of performance of the learning application services.

124. The computer implemented method of claim 120, wherein the service purchase request comprises a time based tutoring service associated with a tutoring user and tutor metadata of the learning application, a time based learning facility access service associated with a learning facility and a learning facility metadata of the learning application; and a learning tool access service associated with the learning tool and a learning tool metadata of the learning application.

125. A computer implemented method for performing a microlearning service comprising one or more learning applications and one or more associated application services stack, the method comprising:
maintaining a plurality of user databases comprising user profile information and preferences for a plurality of users for each distinct user role;
maintaining a learning application database comprising plurality of learning applications, wherein, a learning application further comprising a learning application metadata and an application services metadata associated with the learning application;
maintaining a plurality of application services databases for each distinct application service types;
receiving a microlearning performance request for the learning application and the associated application services stack;
determining learning application compatibility to performance request;
determining availability of associated application services in case the learning application is compatible with the performance request;
processing the performance request for the learning application and the associated application services;
processing a microlearning service performance; and
updating the learning application database, a application services database, a learning user database and user databases of users associated with the application services in a modular learning system.

126. The computer implemented method of claim 125, wherein determining compatibility of the performance request further comprises:
retrieving user profile information and user preferences information associated with the learning user from the learning user database;
retrieving metadata associated with the learning application from the learning application database;
comparing the metadata of the application service associated with the learning application performance with the corresponding learning user information through a performance compatibility module in a performance management module to determine the compatibility; and
denying the performance request by displaying an error interface item on the user device associated with the learning user in case the performance request is incompatible.

127. The computer implemented method of claim 125, wherein determining availability of the requested application services further comprises:
retrieving a set of application service data fields, time inventory or unit inventory data fields and associated user profile information from a plurality of corresponding user databases or a dedicated application services database;
determining a composite availability of all the application services in a requested microlearning stack;
proceeding to process the performance request for the requested microlearning stack in case composite availability of all the application services is available; and
denying the performance request by displaying an error interface item on the user device associated with the learning user in case composite availability of all the application services is unavailable.

128. The computer implemented method of claim 127, wherein determining the composite availability of all the application services in the requested microlearning stack further comprises:
accessing an authenticated check in data of a tutoring user checking in at a requested learning facility at a predetermined time;
accessing authenticated login data of the tutoring user received via the user device at the requested learning facility;
accessing tool availability confirmation data at the predetermined time and duration at a learning facility as entered in via the user device by a learning facility administering user;
accessing the tool availability confirmation data of a predetermined user device, learning station or performance area of the requested learning facility, at the predetermined time for a predetermined duration.

129. The computer implemented method of claim 127, wherein service availability is determined at a predetermined time prior to a scheduled performance time of the requested microlearning stack and at the scheduled performance time of the requested microlearning stack.

130. The computer implemented method of claim 125, wherein processing the microlearning service performance further comprises:
displaying application preview screen on the user device associated with the learning user in case requested application service is available;
displaying application performance screen on the user device associated with the learning user;
displaying application review screen on the user device associated with the learning user;
determining whether a manual review of a performance can be conducted via the user device by the learning user or a user authorized by the learning user;
receiving manual review data when the performance is reviewed via the user device by the learning user or the user authorized by the learning user; and
storing a performance review data in a performance management module.

131. The computer implemented method of claim 125, wherein the performance request comprises a time based tutoring service associated with a tutoring user and tutor metadata of the learning application, a time based learning facility access service associated with a learning facility and learning facility metadata of the learning application, and a tool access service associated with a tool supplying user and tool metadata of the learning application.

132. The computer implemented method of claim 128, wherein determining the composite availability of all the application services in the requested microlearning stack further comprises:
receiving service availability confirmation via the user device associated with a compatible learning facility by the learning user or the learning facility administering user;
receiving service availability confirmation via the user device associated with the learning user;
denying the performance request in case of incompatibility between mode metadata or a performance type metadata of the learning application, and learning user profile information or preferences information, and
denying the performance request in case the learning application or a application service associated with a requested application services stack is not purchased prior to receiving the performance request.

133. The computer implemented method of claim 125, wherein the performance request comprises a predetermined unit of a tutoring user's time, a predetermined unit of access time to a learning facility, a predetermined unit of access time to a learning tool, a predetermined unit of the learning tool, and a predetermined unit of a trial performance associated with the learning application.

134. The computer implemented method of claim 120, wherein the application service comprises
a predetermined unit of a tutoring user's time associated to limited plurality of learning applications;
a predetermined unit of access time to a learning facility associated to the limited plurality of learning applications;
a predetermined unit of access time to a learning tool associated to the limited plurality of learning applications;
a predetermined unit of the learning tool associated to limited plurality of the learning applications;
a predetermined unit of access time to a learning event associated to the limited plurality of learning applications, and
a predetermined unit of a trial performance associated to the limited plurality of learning applications.

135. The computer implemented method of claim 134, wherein a learning event comprises a learning visit or a learning workshop or a plurality of microlearning service stacks, wherein a microlearning service stack comprising one or more learning applications and one or more associated application service.

136. A system for managing purchase and performance of learning applications and associated application service stacks, the system comprising:
a plurality of user databases comprising user profile information and preferences for a plurality of users for each distinct user role;
a learning application database comprising plurality of learning applications, wherein a learning application further comprising a learning application metadata and an application services metadata associated with the learning application;
a plurality of application services databases, each application services database associated with a distinct application service types;
a micro learning purchase management module comprising of a purchase compatibility module, a billing module, a remittance module, an user databases module, a purchase items database module, a purchase interface generator, the learning application database, an age compatibility module and a price range module;
a microlearning performance management module comprising of a performance compatibility module, a service availability module, a ranking module, an user databases module, a performance interface generator, a performance review module, an analysis module, the learning application database and a scoring module; and
a server communicatively connected to a plurality of user devices via a network, wherein each of the plurality of user devices comprises a processor configured for sending a request for at least one learning application and the associated application service, and wherein the server is configured for dynamically determining compatibility of the learning application and associated application services with the request received, using metadata associated with the learning application and learning user information associated with learning users, and wherein the server is configured for providing access to the learning application and the associated application service that provide micro incremental learning experience to the learning users if the learning application and the associated application service is compatible with the request.

137. The system of claim 136, wherein the learning application database comprises of a scoring metrics metadata, a performance type metadata, a subject link/tag metadata, a learning facility metadata, a certification metadata, a language metadata, a duration metadata, an age level metadata, a tutor metadata, an error metadata, a medium metadata, a mode metadata, a sequence metadata, a template metadata, a job skill metadata, a media metadata, a tool metadata, a learning event metadata and an authoring metadata associated with the learning application.

138. The system of claim 136, wherein the application services database comprises
a predetermined unit of a tutoring user's time;
a predetermined unit of access time to a learning facility, wherein the learning facility comprises an independent learning facility, an institutional learning facility, a workspace learning facility, a temporary learning facility, a tutor managed learning facility associated with a tutoring user and a plurality of learning stations associated with a limited plurality of the learning applications;
a predetermined unit of access time to a learning tool;
a predetermined unit of the learning tool;
a predetermined unit of a trial performance associated with limited plurality of learning applications; and
a predetermined unit of access time to a learning event, wherein the learning event comprises a learning visit, or a learning workshop.

139. The system of claim 137, wherein
updating of certification metadata of the learning application is limited to a predetermined plurality of certifying users and recruiting users;
updating of scoring metrics metadata, performance type metadata, age level metadata, authoring metadata, mode metadata, media metadata, medium metadata, and error metadata of the learning application is limited to a predetermined plurality of learning application authoring users;
updating of language metadata of the learning application is limited to a learning application translating user;
updating of duration metadata of the learning application is limited to a plurality of learning application authoring users and a learning application template developing users;
updating of a subject link/tag metadata of the learning application is limited to a predetermined plurality of users in any of the user role;
updating of learning facility metadata of the learning application is limited to a predetermined plurality of learning facility administering users;
updating of sequence metadata of the learning application is limited to the predetermined plurality of learning application authoring users and tutoring users;
updating of tool metadata of the learning application is limited to a predetermined plurality of tool supplying users;
updating of job skill metadata of the learning application is limited to a predetermined plurality of recruiting users;
updating of template metadata of the learning application is limited to a predetermined plurality of template developing users;
updating of tutor metadata of the learning application is limited to a predetermined plurality of tutoring users, and
updating of learning event metadata of the learning application is limited to a predetermined plurality of learning workshop organizing users and learning visit organizing users.

140. A computer readable storage medium having tangibly embodied thereon a program of instructions executable by a processor for performing a method for purchasing a microlearning service comprising at least one learning application and at least one associated application services stack, the method comprising:
maintaining a plurality of user databases, each user database associated with a distinct user role and comprising user profile information and preferences for a plurality of users;
maintaining a learning application database comprising a plurality of learning applications, wherein a learning application comprising learning application metadata and application services metadata;
maintaining a plurality of application services databases, each application services database associated with an application service types and comprising learning services;
receiving a learning application purchase request from a user device associated with a learning user via a network, wherein the learning user is associated with a user profile in one of the plurality of user databases, and the learning application purchase request indicates a requested learning application of the plurality of learning applications;
determining a compatibility of the requested learning application to the learning application purchase request;
processing a purchase transaction for the learning application purchase request;
storing the learning application in an account associated with the learning user;
receiving a service purchase request for an application service from the user device associated with the learning user;
determining the compatibility of the learning application to requested application service; and
processing the purchase transaction for the service purchase request.

141. The computer readable storage medium of claim 140, wherein determining the compatibility of the purchase request further comprises:
retrieving user profile information and user preferences information associated with the learning user from a learning user database;
retrieving metadata associated with the learning application from the learning application database;
comparing the metadata of the learning application with corresponding learning user information through a purchase compatibility module in a purchase management module to determine the compatibility; and
denying the purchase request transaction by displaying an error interface item on the user device associated with the learning user in case the purchase request is incompatible.

142. The computer readable storage medium of claim 140, wherein determining the compatibility of the requested application service further comprises:
retrieving user profile information and user preferences information associated with the learning user from a learning user database;
retrieving application service data fields and associated user profile information from a plurality of corresponding user databases of application service providers or optionally, a dedicated application services database;
retrieving metadata associated with the learning application from the learning application database;
comparing the metadata of the application service is associated with the learning application purchased with corresponding learning user information through a purchase compatibility module in a purchase management module to determine the compatibility; and
denying the purchase request transaction by displaying an error interface item on the user device associated with the learning user in case the purchase request is incompatible.

143. The computer readable storage medium of claim 142, wherein the application service's attributes are an address or geographic location of service availability, and the corresponding learning user profile information and/or user preference is the address or geographic location of performance of the learning application services.

144. A non-transitory computer readable storage medium having tangibly embodied thereon a program of instructions executable by a processor for performing a method for performing a microlearning service comprising a learning application and associated application services stack, the method comprising:
maintaining a plurality of user databases comprising user profile information and preferences for a plurality of users for each distinct user role;
maintaining a learning application database comprising learning applications, said learning application further comprising learning application metadata and application services metadata associated with the learning application;
maintaining a plurality of application services databases for each distinct application service types;
receiving a microlearning performance request for the learning application and the associated application services stack;
determining learning application compatibility to performance request;
determining availability of associated application services in case the learning application is compatible with the performance request;
processing the performance request for the learning application and the associated application services;
processing a microlearning service performance; and
updating the learning application database, a application services database, a learning user database and user databases of users associated with the application services in a modular learning system.

145. The computer readable storage medium of claim 144, wherein determining compatibility of the performance request further comprises:
retrieving user profile information and user preferences information associated with the learning user from the learning user database;
retrieving metadata associated with the learning application from the learning application database;
comparing the metadata of the application service associated with the learning application performance with the corresponding learning user information through a performance compatibility module in a performance management module to determine the compatibility; and
denying the performance request by displaying an error interface item on the user device associated with the learning user in case the performance request is incompatible.

146. The computer readable storage medium of claim 144, wherein determining availability of the requested application services further comprises:
retrieving a set of application service data fields, time inventory or unit inventory data fields and associated user profile information from a plurality of corresponding user databases or a dedicated application services database;
determining a composite availability of all the application services in a requested microlearning stack;
proceeding to process the performance request for the requested microlearning stack in case composite availability of all the application services is available; and
denying the performance request by displaying an error interface item on the user device associated with the learning user in case composite availability of all the application services is unavailable.

147. The computer readable storage medium of claim 146, wherein determining the composite availability of all the application services in the requested microlearning stack further comprises:
accessing an authenticated check in data of a tutoring user checking in at a requested learning facility at a predetermined time;
accessing authenticated login data of the tutoring user received via the user device at the requested learning facility;
accessing tool availability confirmation data at the predetermined time and duration at a learning facility as entered in via the user device by a learning facility administering user;
accessing the tool availability confirmation data of a predetermined user device, learning station or performance area of the requested learning facility, at the predetermined time for a predetermined duration.

148. The computer readable storage medium of claim 146, wherein service availability is determined at a predetermined time prior to a scheduled performance time of the requested microlearning stack and at a scheduled performance time of the requested microlearning stack.

149. The computer readable storage medium of claim 144, wherein processing the microlearning service performance further comprises:
displaying application preview screen on the user device associated with the learning user in case requested application service is available;
displaying application performance screen on the user device associated with the learning user;
displaying application review screen on the user device associated with the learning user;
determining whether a manual review of a performance can be conducted via the user device by the learning user or a user authorized by the learning user;
receiving manual review data when the performance is reviewed via the user device by the learning user or the user authorized by the learning user; and
storing performance review data in a performance management module.

150. The computer readable storage medium of claim 144, wherein determining compatibility of the performance request further comprises,
denying the performance request in case of incompatibility between mode metadata or performance type metadata of the learning application, and learning user profile information or preferences information;
denying the performance request in case at least one learning application or at least one application service associated with a requested application services stack is not purchased prior to receiving the performance request, and
denying the performance request in case the performance request is incompatible with learning user profile information or preferences information, and metadata of the learning application.
